(19) United States
(12) Patent Application Publication
(10) Pub. No.: US 2026/0323561 A1
(43) Pub. Date: Oct. 15, 2026

(54) MULTIPLE ACCESS NETWORK HANDLING

(71) Applicant: KONINKLIJKE PHILIPS N.V., EINDHOVEN (NL)

(72) Inventors: SungDuck Chun, Reston, VA (US); Peyman Telebi Fard, Reston, VA (US); Esmael Hejazi Dinan, Reston, VA (US); Hendrik Andreas Normann, Reston, VA (US); Walter Dees, Eindhoven (NL)

(21) Appl. No.: 19/486,170

(22) PCT Filed: May 31, 2024
(86) PCT No.: PCT/EP2024/065115

§ 371 Date: Nov. 20, 2025

Related U.S. Application Data
(60) Provisional application No. 63/470,357, filed on Jun. 1, 2023.

(30) Foreign Application Priority Data
May 17, 2024 (EP) 24176799.5

(51) Int. Cl. H04W 60/00; H04W 48/18

(52) U.S. Cl. CPC H04W 60/005; H04W 48/18

(57) ABSTRACT

This invention relates to a method comprising: sending, by a wireless device to a first mobility management node of a network, a first message indicating support for a secondary registration to a secondary network associated with the network; receiving, by the wireless device from the first mobility management node, a second message comprising information of an allowed network for the secondary registration; and sending, by the wireless device to a second mobility management node of the allowed network, a third message requesting the secondary registration.

### FIELD OF THE INVENTION

The invention relates to a method and corresponding devices adapted to manage a set of multiple connections, for example in connection with cellular communication. In some embodiments, these connections may be 5G communications or 6G, or could be based on other technologies, such as WLAN.

### BACKGROUND OF THE INVENTION

As 5G system (5GS) advances, 3GPP accesses may also advance. As shown in the FIG. 20, one or more 3GPP RANs may be diversified and/or may be deployed in differentiated areas. In existing technologies, an access node and/or a radio access network may be deployed as a terrestrial node (on the ground) or with similar frequencies (e.g., 2Ghz). In other words, the access node may be deployed on the ground, in the building and/or the like, and due to limitation of supported frequencies, may use similar frequency bands. As a result, there may not be much gain in differentiating a (e.g., first type) 3GPP RAN from other (e.g., second type) 3GPP RANs. As 5G system equipment becomes smaller and signal of UEs with limited power become capable of reaching satellites, deploying the 3GPP access nodes onto the satellites may become feasible. For example, a first NG-RAN of the one or more 3GPP RANs may be deployed over a geostationary equatorial orbit (GEO). For example, a second NG-RAN of the one or more 3GPP RANs may be deployed over a low earth orbit (LEO). For example, a third NG-RAN of the one or more 3GPP RANs may be deployed as a terrestrial (e.g., on the ground, in the building) access network. For example, a fourth E-UTRAN of the one or more 3GPP RANs may be deployed as a terrestrial access network. These different 3GPP RANs may provide different characteristics. For example, the first NG-RAN may provide a coverage in a remote area where terrestrial 3GPP RANs cannot be deployed. For example, the second NG-RAN may provide a wider coverage than the terrestrial NG-RAN, with a reduced throughput. For example, the one or more 3GPP RAN may be connected to one or more 3GPP core networks. For example, the one or more 3GPP core networks may belong to one or more networks. For example, the first NG-RAN and/or the second NG-RAN may be connected to a first core network. For example, the third NG-RAN may be connected to a second core network. For example, the first core network may belong to a first network. For example, the third NG-RAN may be connected to a second core network. For example, the first core network may belong to a first network and/or a first operator. For example, the second core network may belong to a second network and/or a second operator. In these diversified scenarios, it may be beneficial to use multiple 3GPP RANs or networks for the UE because the UE can then connect to suitable RANs or networks depending on the required services, however, this leads to multiple problems, e.g, how should the UE select the networks or RANs it has to use.

### SUMMARY OF THE INVENTION

It is an aim of the invention to alleviate the above described problems.

It is another aim of the invention to provide with a more robust process, reducing the connection latency, or proposing acceptable fallback solutions while keeping the processing time small.

It is still another aim of the invention to propose a method for the mobility management of a wireless device within a network.

To this end, it is proposed a method as claimed in claims 1, 3, 32, 33, 34, 35, 36, 37, 38, 39, 40, 41 and 42, a device as claimed in claims 43 or 44.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15A and FIG. 15B are diagrams of aspect(s) of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

FIG. 32 is a diagram of an aspect of an example embodiment of the present disclosure.

FIG. 33 is a diagram of an aspect of an example embodiment of the present disclosure.

FIG. 34 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

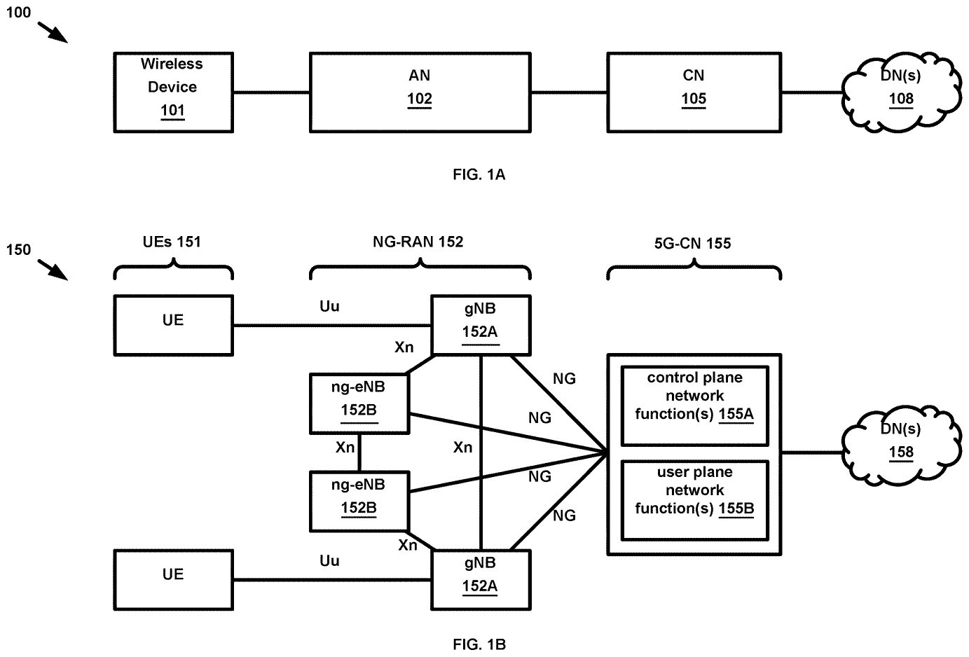

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IOT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NGC interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

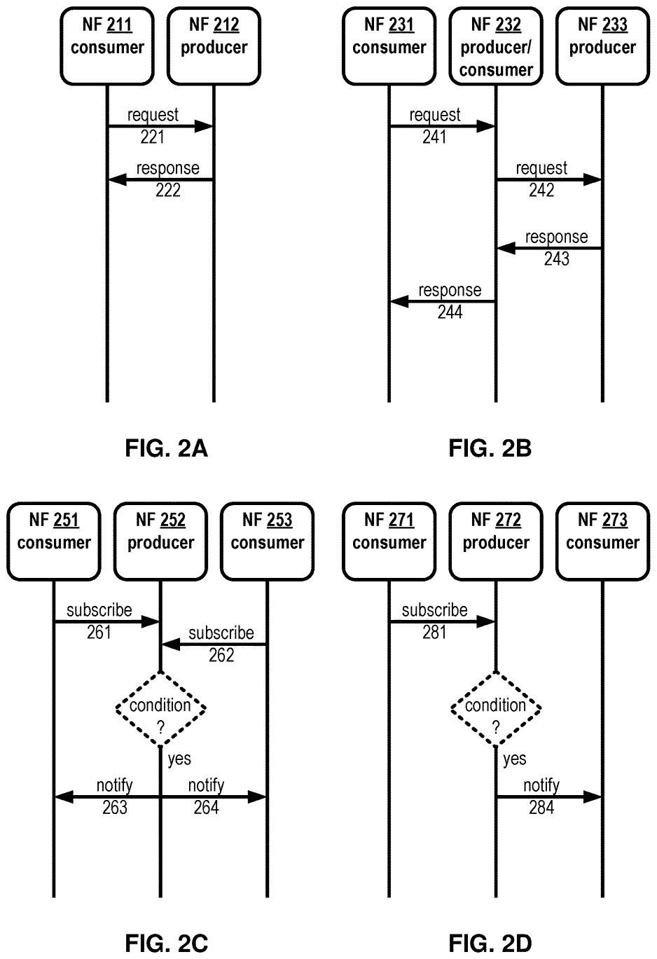

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

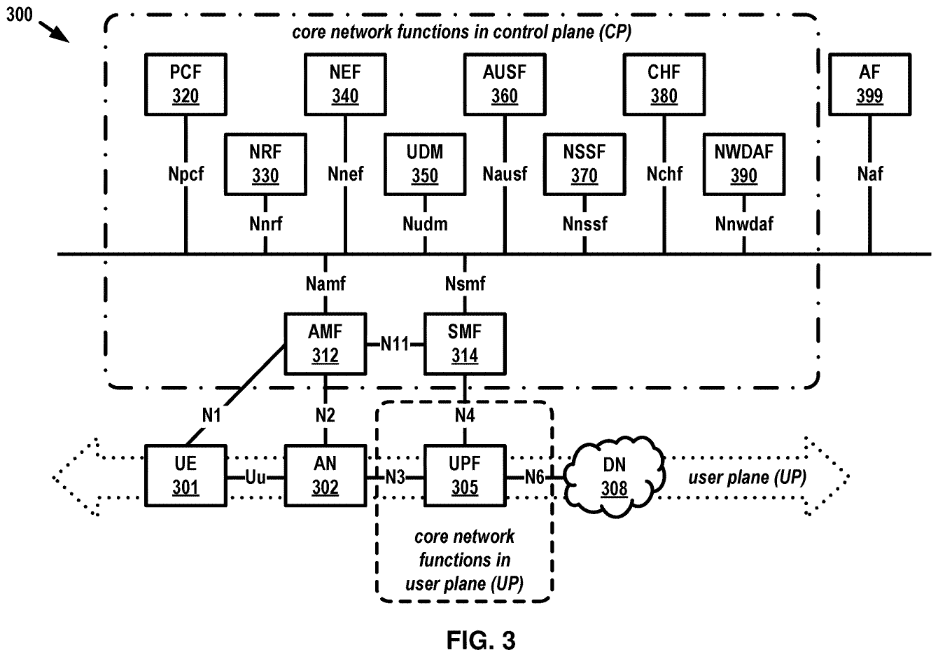

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NGU interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QOS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

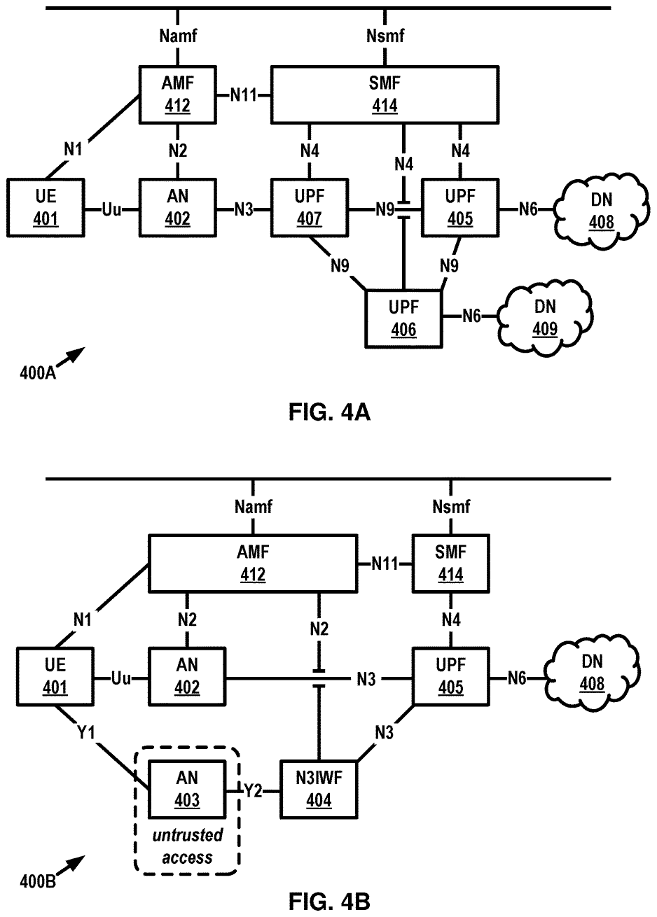

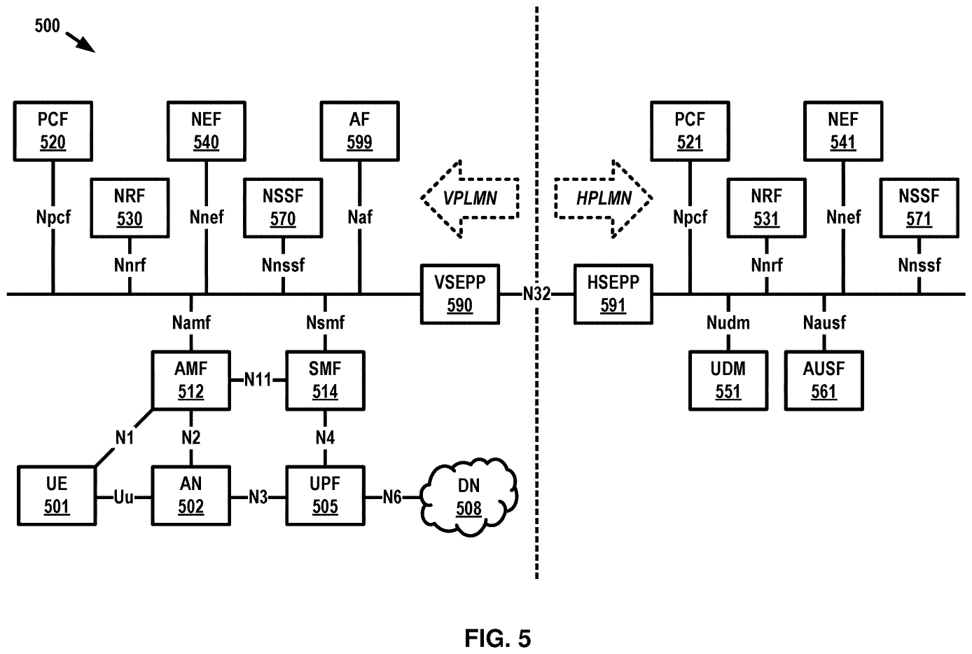

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QOS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

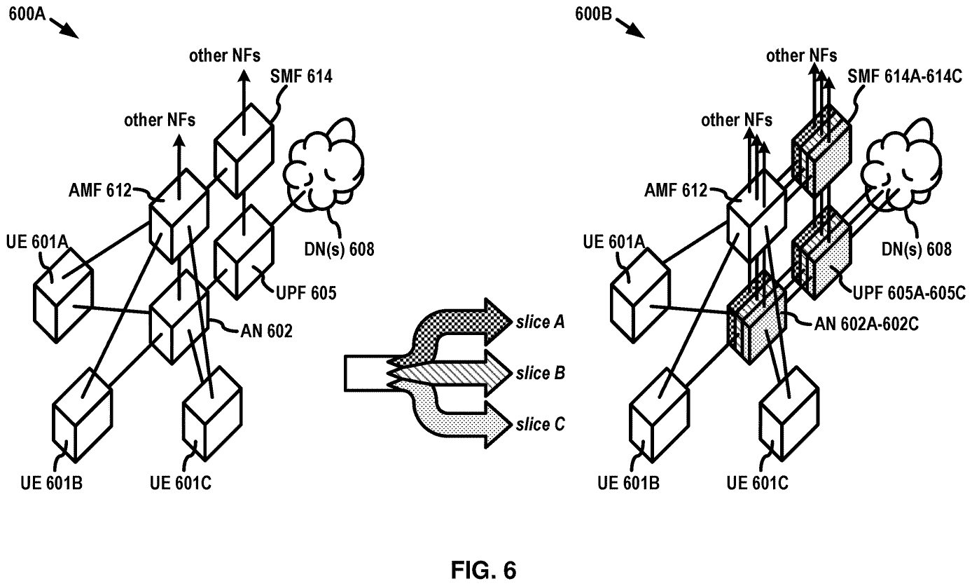

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (SNSSAI). The SNSSAI may include a particular slice/service type (SST) indicator (indicating eMBB, URLLC, mMTC, etc.). as an example, a particular tracking area may be associated with one or more configured SNSSAIs. UEs may identify one or more requested and/or subscribed SNSSAIs (e.g., during registration). The network may indicate to the UE one or more allowed and/or rejected SNSSAIS.

The SNSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

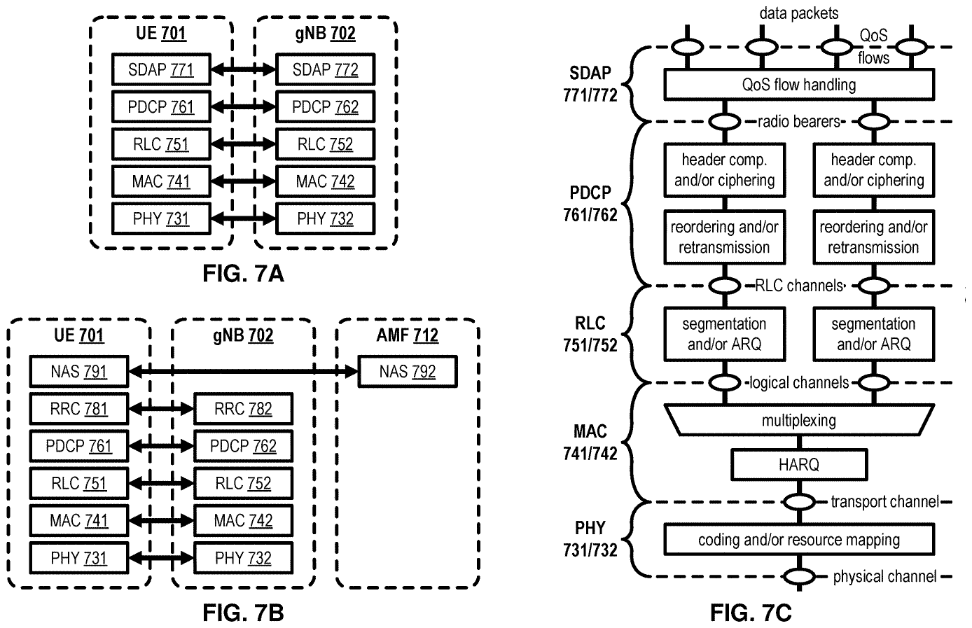

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QOS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

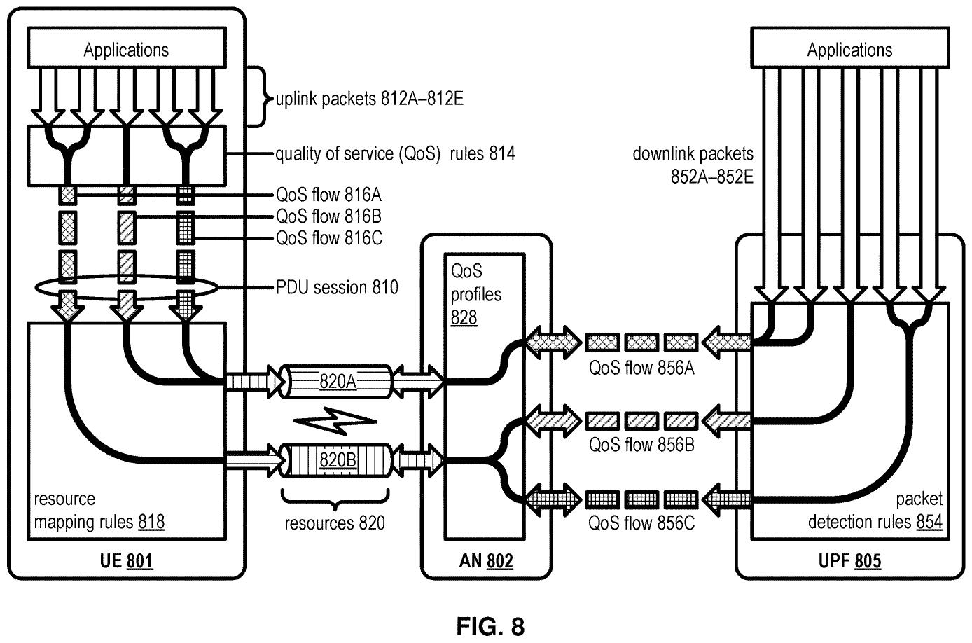

FIG. 8 illustrates an example of a quality of service (QOS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QOS flows) and others may have bit rates that are not guaranteed (non-GBR QOS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QOS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QOS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which have one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QOS flow, a GBR QOS flow or a delay-critical GBR QOS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QOS flow 856C.

The QoS flows 856A-856C may be sent to AN 802. The AN 802 may apply resource mapping rules to the QOS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QOS flows.

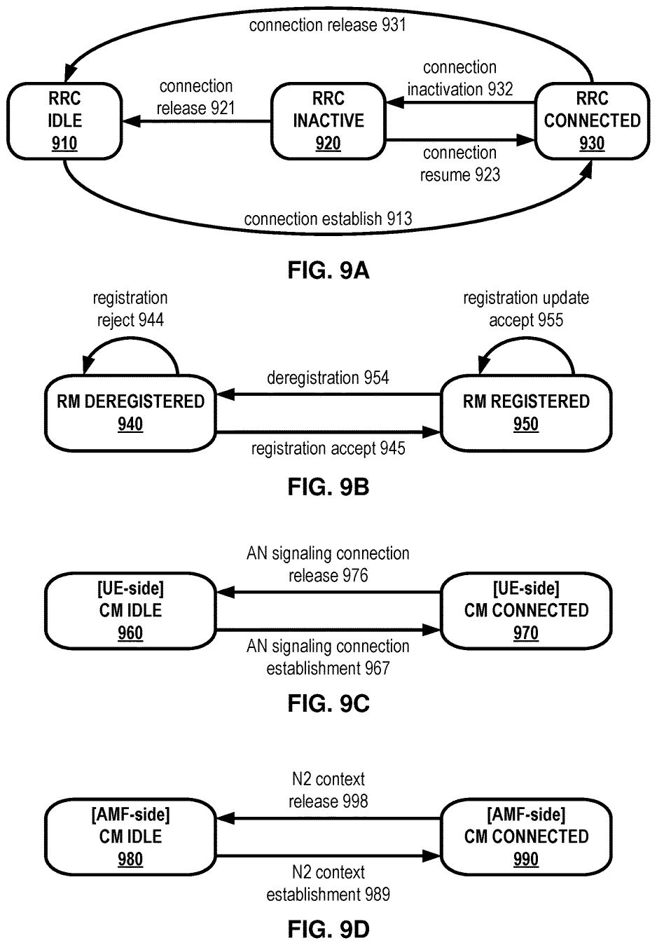

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

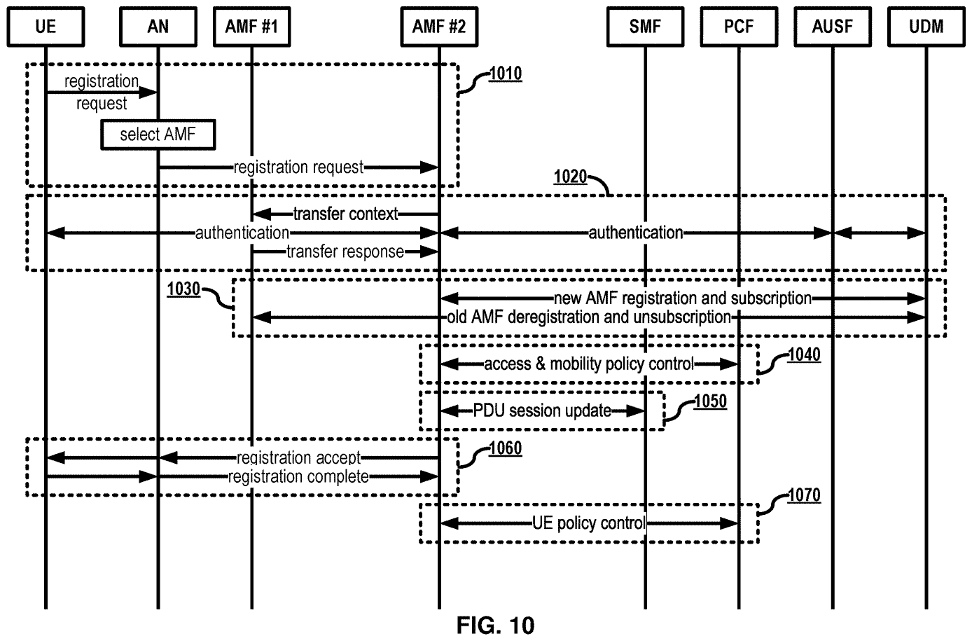

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf PDUSession ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

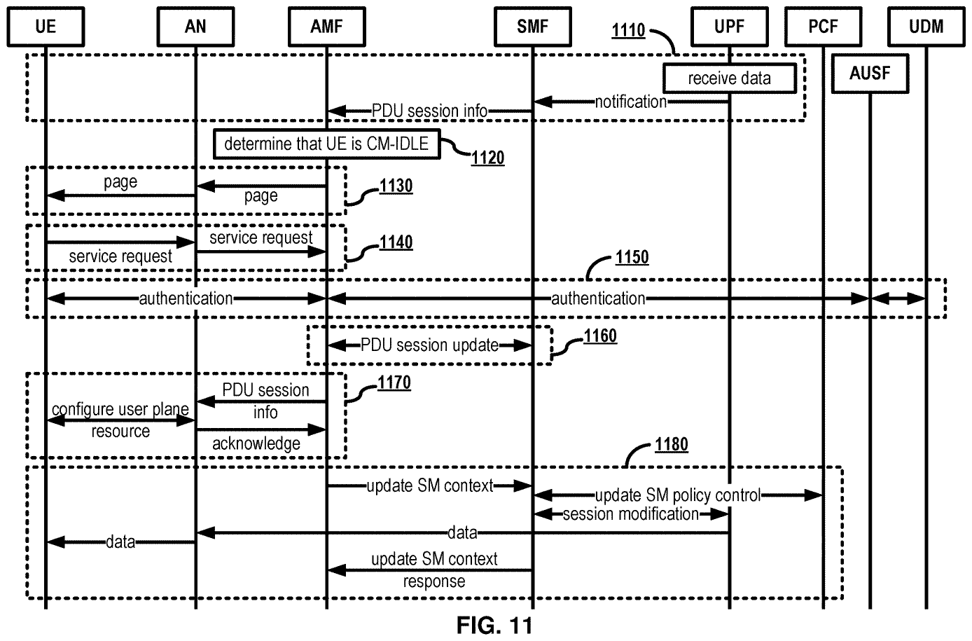

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

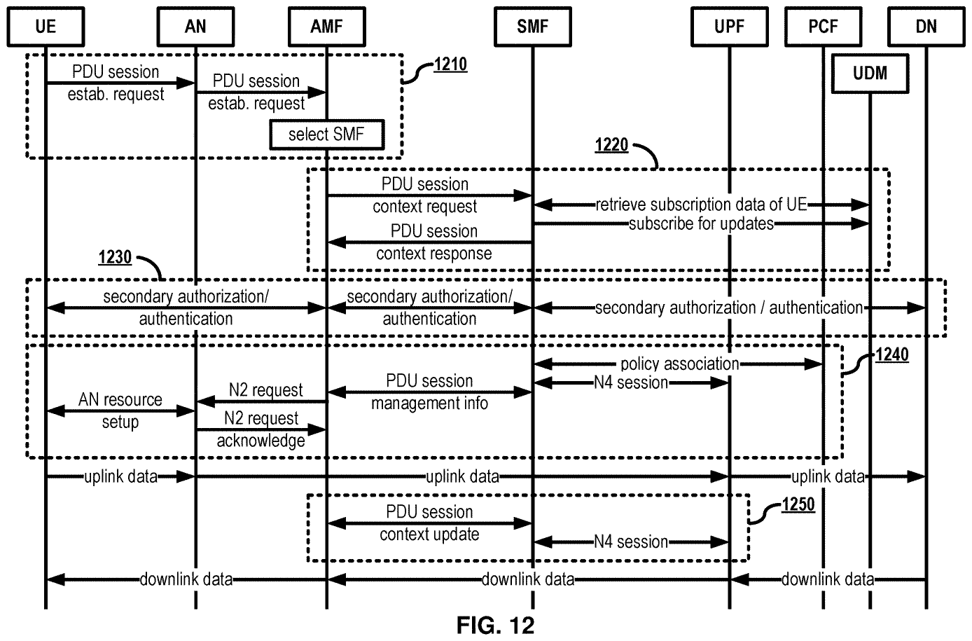

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QOS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

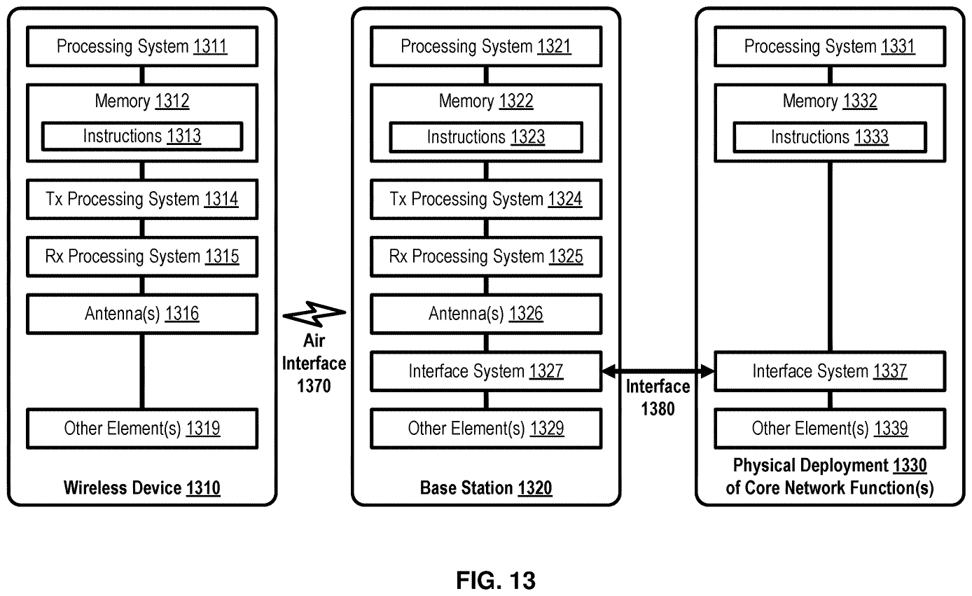

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or Lab VIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

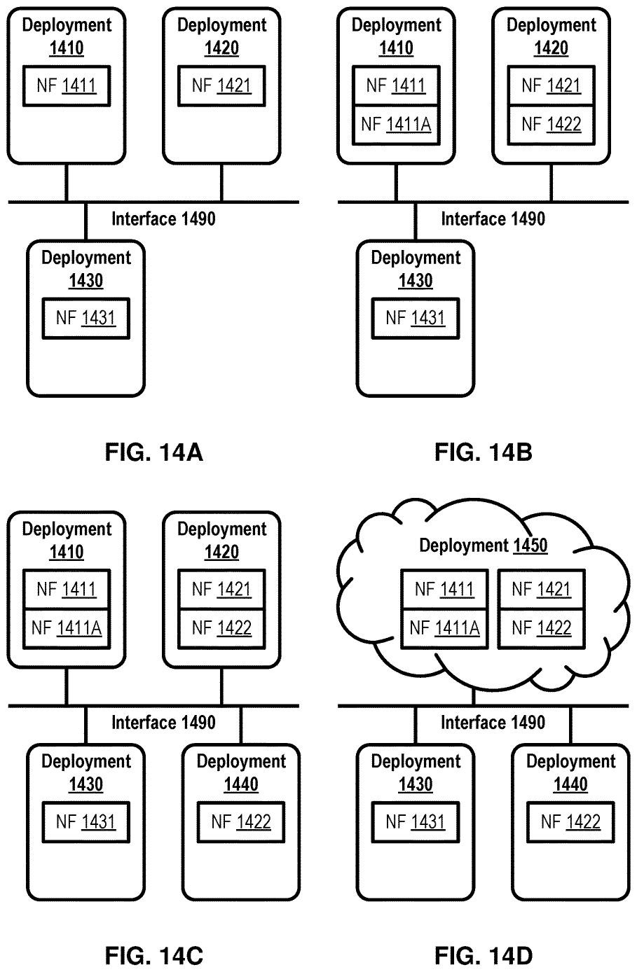

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (ORAN) standards.

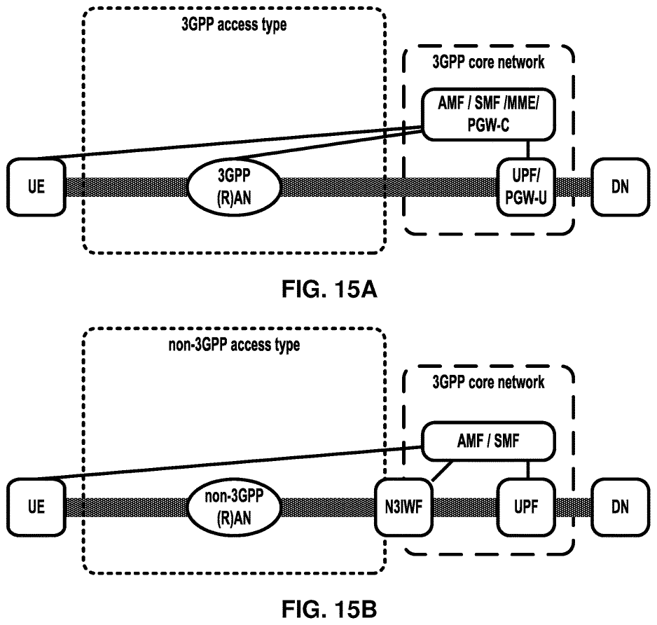

In an example embodiment as depicted in FIG. 15A and FIG. 15B, a UE may access a 3GPP system (network) via (using) one or more access types. For example, the one or more access types may comprise at least one of a 3GPP access type, a non-3GPP (N3GPP) access type, and/or a combination thereof.

For example, as shown in FIG. 15A, the UE may access a network via the 3GPP access type. For example, the access to the network via the 3GPP access type may be an access to the network via one or more 3GPP RANs. For example, the one or more 3GPP RANs may comprise at least one of a global system for mobile communication (GSM) enhanced data-rates for global evolution (EDGE) radio access network (GERAN), a universal terrestrial radio access network (UTRAN), an evolved UTRAN (E-UTRAN), a next generation radio access network (NG-RAN), and/or a combination thereof. An operator of the network may trust a UE's access to the network via the 3GPP access type, because the one or more 3GPP RANs are managed and/or deployed by the operator.

For example, as shown in FIG. 15B, the UE may access the network via the N3GPP access (e.g., N3GPP access type). For example, the access to the network via the N3GPP access type may be an access to the network via one or more N3GPP RANs (or N3GPP AN). For example, the one or more N3GPP RANs may comprise at least one of a trusted WiFi, an untrusted WiFi, a wireline broadband, a WiMAX, and/or a combination thereof. The operator of the network may not trust the access to the network via the N3GPP access type, because the one or more N3GPP RANs may not be managed and/or deployed by the operator. To prevent unauthorized access of the UE via the one or more N3GPP RANs and/or to protect data/signalling, a non-3GPP interworking function (N3IWF) may be employed for the N3GPP access type. For example, the N3IWF may be employed for interworking between the one or more non-3GPP RANs and a 5G core network.

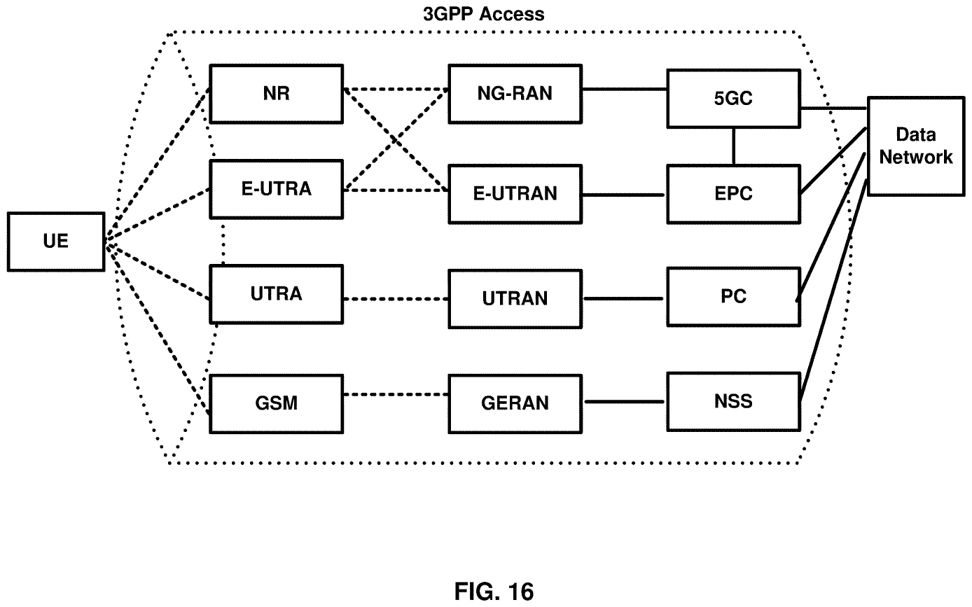

In an example embodiment as depicted in FIG. 16, the UE may exchange one or more data with a data network (DN), via the 3GPP access (type). The 3GPP access (type) may use one or more 3GPP RATs. The one or more 3GPP RATs may comprise at least one of NR, E-UTRA, UTRA, GSM, the like and/or a combination thereof. The 3GPP access may use one or more 3GPP RANs. The one or more 3GPP RANs may comprise at least one of the NG-RAN, the E-UTRAN, the UTRAN, the GERAN, the like and/or a combination thereof. The 3GPP RANs may use the one or more 3GPP RATs. The one or more 3GPP RANs may interface with a one or more core networks. The one or more core networks may comprise at least one of a 5G core (5GC), an evolved packet core (EPC), a packet core (PC), a network switching system (NSS), and/or a combination thereof.

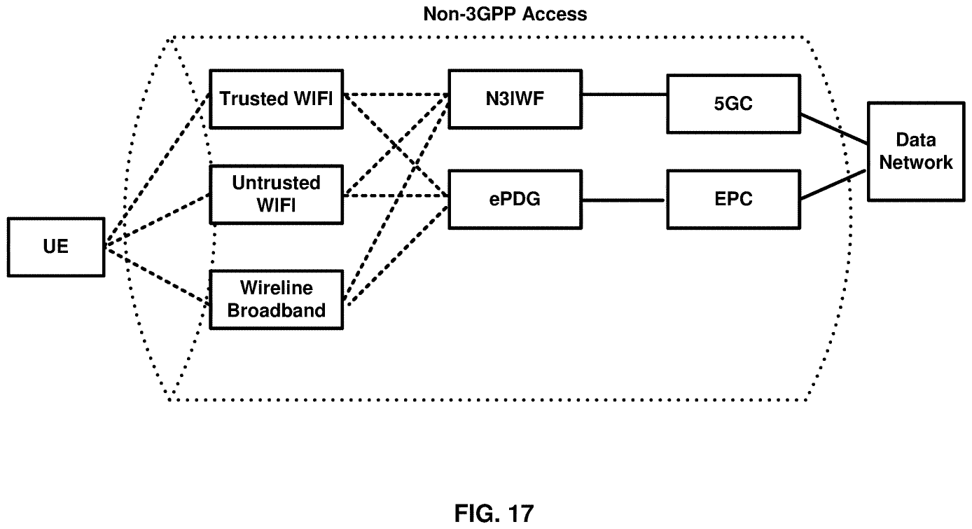

In an example embodiment as depicted in FIG. 17, the UE may exchange one or more data with the data network, via the N3GPP access (type). The N3GPP access may use one or more N3GPP RATs. The one or more N3GPP RATs may comprise at least one of the trusted WiFi, the untrusted WiFi, the wireline broadband, the like and/or a combination thereof. The N3GPP access may use one or more N3GPP access network (nodes). The one or more N3GPP access network nodes may comprise at least one of the N3IWF, an evolved packet data gateway (ePDG), a trusted non-3GPP gateway function (TNGF), a wireline access gateway function (W-AGF), the like and/or a combination thereof. The one or more N3GPP access nodes may interface with the one or more core networks (e.g., EPC and/or 5GC).

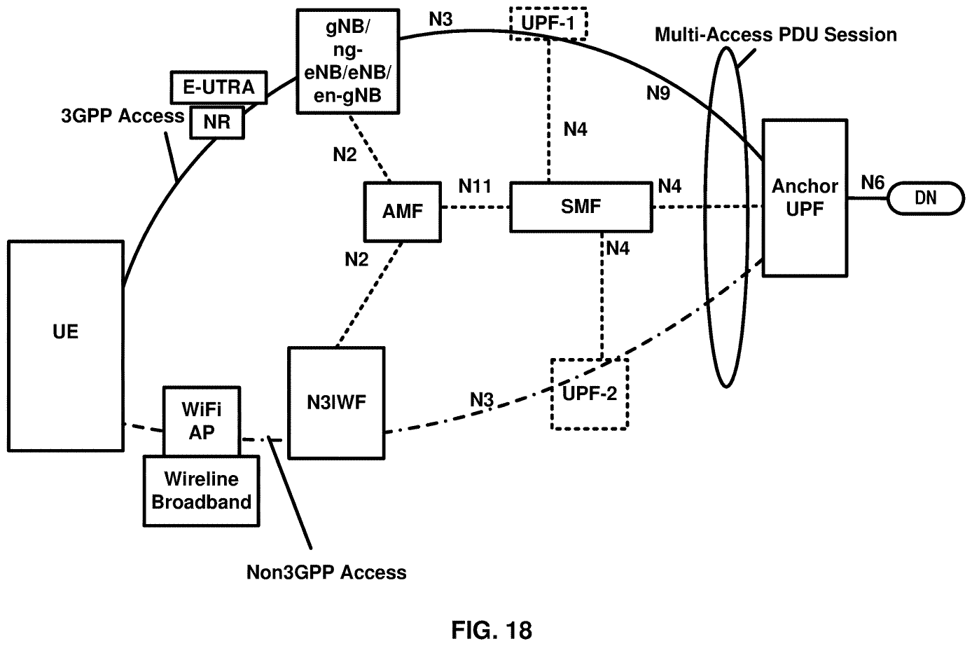

In an example embodiment as depicted in FIG. 18, the UE may establish a multi access PDU (MA PDU) session with the network. The MA-PDU session may be supported if the UE and the network support an access traffic steering switching splitting (ATSSS) feature (the feature of ATSSS). The ATSSS feature may enable a MA PDU connectivity service, which may exchange one or more PDUs between the UE and the data network by a first tunnel (e.g., a N3/N9 tunnels between a UPF (e.g., an anchor UPF, a packet switching anchor) and the 3GPP RAN) of one 3GPP access and a second tunnel (e.g., a N3/N9 tunnels between the UPF and the N3GPP RAN) of one non-3GPP access. The MA PDU connectivity service may be realized by establishing the Multi Access PDU (MA PDU, MA-PDU) Session. The MA PDU session may be a PDU Session that may have user-plane resources on the 3GPP access and the N3GPP access. For example, the resources on the 3GPP access may comprise resources provided by the 3GPP RATs (e.g., E-UTRA, NR), the 3GPP RAN nodes (e.g., gNB, ng-eNB, eNB, en-gNB, the like, and/or a combination thereof), a first UPF (UPF-1, if configured between the anchor UPF the 3GPP RAN), the anchor UPF, and/or the like. For example, the resources on the N3GPP access may comprise resources provided by the N3GPP RATs (e.g., WiFi, WiMAX, wireline broadband, and/or the like), the N3GPP RAN nodes (e.g., ePDG, N3IWF, TNGF, W-GAN, the like, and/or a combination thereof), a second UPF (UPF-2, if configured between the anchor UPF the N3GPP RAN), the anchor UPF and/or the like. For the MA PDU session, the data network or applications of the UE may use the same identity (e.g., IP address). For example, source IP address (and/or destination IP address) of the packets (e.g., PDUs) of the MA PDU session sent over the 3GPP access may be same as the source IP address (and/or destination IP address) of the packets of the MA PDU sent over the N3GPP access.

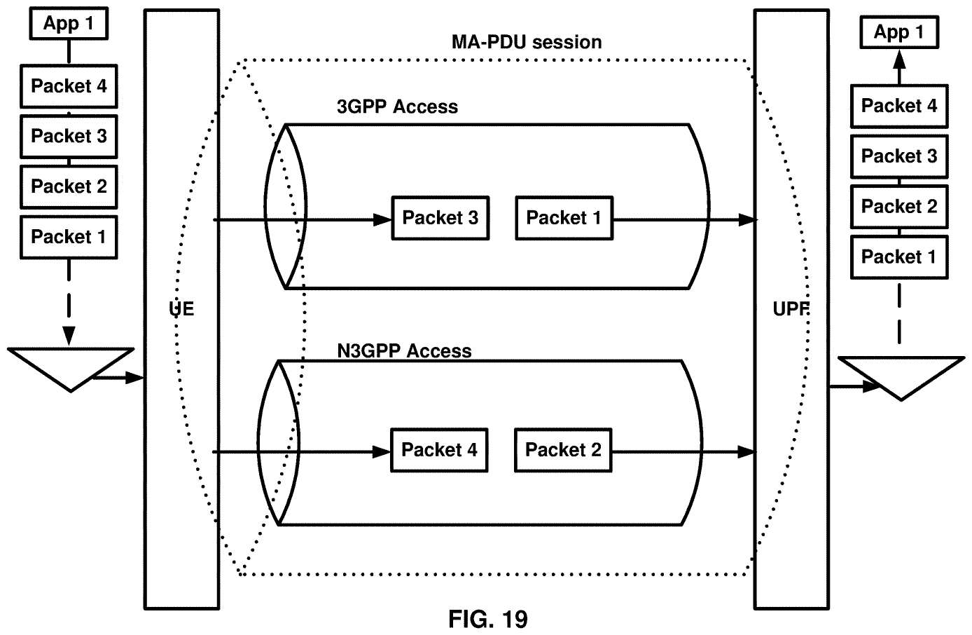

In an example, using two resources for the MA PDU session may provide enhanced reliability, efficient use of network resources, and/or adaptation to changing environment. For example, as depicted in FIG. 19, the UE and the UPF (e.g., anchor UPF) may establish the MA PDU session. The MA PDU session may comprise the 3GPP access and the N3GPP access. For example, the 3GPP access may use the resources as shown in FIG. 18 and/or the N3GPP access may use the resources as shown in FIG. 18. Reverting back to FIG. 19, the 3GPP access and the N3GPP access may provide different characteristics of data transfer. For example, the 3GPP access may provide a wider coverage than the N3GPP access. For example, the N3GPP access may provide higher throughput than the N3GPP access. By utilizing these different characteristics of the two accesses, the operator of the network may determine how to transport the PDUs over the two accesses of the MA PDU session. For example, if both accesses provides similar performance, the operator may determine to distribute loads equally on these accesses. For example, a half (e.g., packet 1 and packet 3) of the PDUs may be transferred over the 3GPP access while the remaining half of the PDUs (e.g., packet 2 and packet 4) may be transferred over the N3GPP access. In other example (not shown in the figure), if transfer delay (e.g., 30 ms) over the 3GPP access is three times larger than the transfer delay (e.g., 10 ms) over the N3GPP access, the operator may determine to send three times more PDUs (e.g., packet 6, packet 7, packet 8) over the N3GPP access than the PDUs (e.g., packet 5) sent over the 3GPP access. In existing technologies, for the MA PDU session, a core network node (e.g., AMF, SMF, UPF) may be able to distinguish one access type (e.g., 3GPP access type) from the other access type (e.g., N3GPP access type), because different network nodes (e.g., gNB, N3IWF) are used for each access.

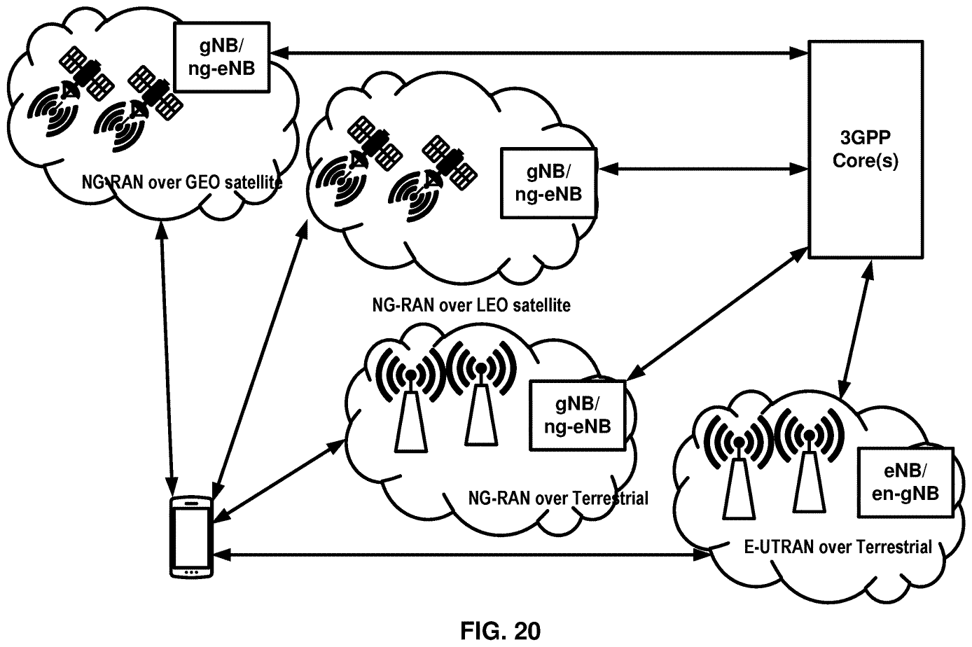

As 5G system (5GS) advances, 3GPP accesses may also advance. As shown in the FIG. 20, one or more 3GPP RANs may be diversified and/or may be deployed in differentiated areas. In existing technologies, an access node and/or a radio access network may be deployed as a terrestrial node (on the ground) or with similar frequencies (e.g., 2 Ghz). In other words, the access node may be deployed on the ground, in the building and/or the like, and due to limitation of supported frequencies, may use similar frequency bands. As a result, there may not be much gain in differentiating a (e.g., first type) 3GPP RAN from other (e.g., second type) 3GPP RANs. As 5G system equipment becomes smaller and signal of UEs with limited power become capable of reaching satellites, deploying the 3GPP access nodes onto the satellites may become feasible. For example, a first NG-RAN of the one or more 3GPP RANs may be deployed over a geostationary equatorial orbit (GEO). For example, a second NG-RAN of the one or more 3GPP RANs may be deployed over a low earth orbit (LEO). For example, a third NG-RAN of the one or more 3GPP RANs may be deployed as a terrestrial (e.g., on the ground, in the building) access network. For example, a fourth E-UTRAN of the one or more 3GPP RANs may be deployed as a terrestrial access network. These different 3GPP RANs may provide different characteristics. For example, the first NG-RAN may provide a coverage in a remote area where terrestrial 3GPP RANs cannot be deployed. For example, the second NG-RAN may provide a wider coverage than the terrestrial NG-RAN, with a reduced throughput. For example, the one or more 3GPP RAN may be connected to one or more 3GPP core networks. For example, the one or more 3GPP core networks may belong to one or more networks. For example, the first NG-RAN and/or the second NG-RAN may be connected to a first core network. For example, the third NG-RAN may be connected to a second core network. For example, the first core network may belong to a first network. For example, the third NG-RAN may be connected to a second core network. For example, the first core network may belong to a first network and/or a first operator. For example, the second core network may belong to a second network and/or a second operator. In these diversified scenarios, it may be beneficial to use multiple 3GPP RANs for the UE and/or for the MA PDU session, instead of using one 3GPP access and one N3GPP access. However, this may bring a problem as explained below.

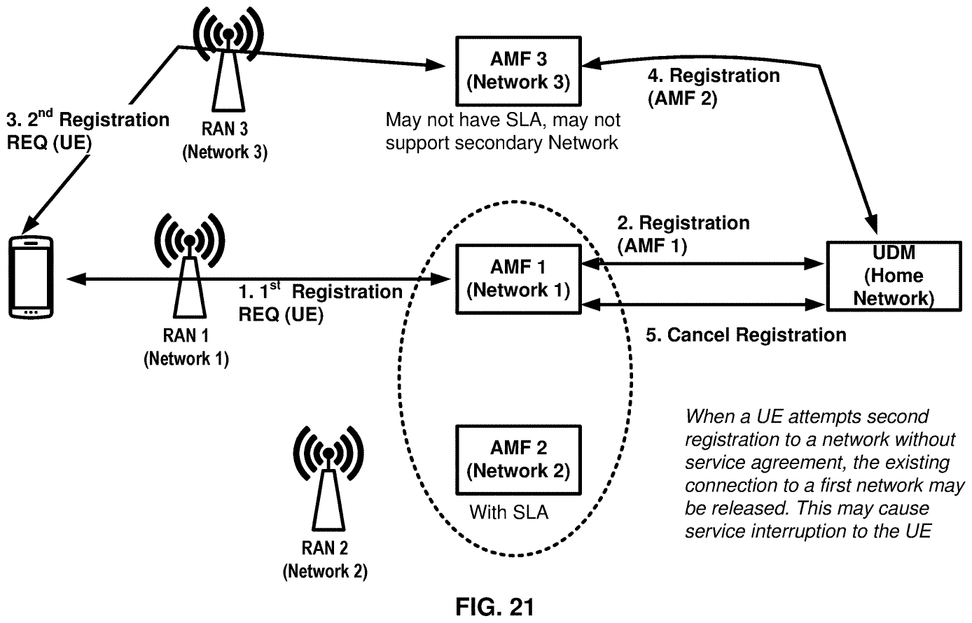

In an example embodiment as depicted in FIG. 21, a UE may register to one or more core network nodes (or core networks, networks).

In an example, the UE may send a first message (e.g., a registration request message) to a first core network node (e.g., an AMF, an MME, and/or the like) of a first network. In response to receiving the first message, the first core network node may register the first core network node (e.g., a mobility management node) at a data management node (e.g., a UDM) of a home network. For example, the home network may manage a subscription of the UE. For example, the first core network node may send a second message (e.g., a Nudm message) to the data management node, for the UE, to register the first core network node in the data management node. After registration to the first network, the UE may determine to perform a registration to another network. For example, to use a MA-PDU session using resources of multiple networks, the UE may determine to perform the registration to the another network. For example, the UE may search one or more available networks. For example, the UE may find a second network and/or a third network. For example, if (based on that) the signal strength of a third cell of the third network is stronger than the signal strength of a second cell of the second network, the UE may select the third network for another registration.

In an example, the UE may send a third message to the third network. For example, the third message may request registration to the third network. A third core network node (e.g., AMF 3) of the third network may receive the third message. Based on receiving the third message, and/or based on that the UE has subscription with the home network, the third core network node may determine to register the third core network node at the data management node of the home network. For example, the third core network node may send a fourth message to the data management node.

In an example, the data management node may receive the fourth message. In response to receiving the fourth message, based on that the fourth message is received from the third network, and/or based on that the first core network node of the first network is registered for the UE, the data management node may determine at least one of that the UE changes location, that the UE moves from the first network to the third network. For example, based on the determination, based on that the third network does not support the another registration, and/or based on that the first network does not have a service agreement with the third network, the data management node may cancel registration of the first core network node for the UE and may allow registration of the third core network node at the data management node. For example, the first core network node and/or the first network may remove information of the UE from the first network and/or may stop to provide any resource for data communication to the UE.

In an example, the UE may lose registration in the first network and/or in the first core network node. The UE may not be able to use a first RAN of the first network and/or may not be able to use the first RAN with other RANs of other networks, for reliability and/or data rate increase. The existing technologies may cause the UE to connect to a non-supporting network (or a network without a service level agreement with other network for using multiple RANs/core networks/networks), may reduce opportunity for data connectivity (e.g., MA-PDU session) for a UE, and/or may increase signalling exchanges caused by cancellation of registration.

In another example, the UE may use one or more subscriptions (e.g. the UE may be equipped with multiple USIMs and/or multiple SUPIs and/or may operate two logically separate (partial) UE implementations (e.g. two separate protocol stacks) in the same UE. Such UE may be able to support a secondary registration to a second network. However, those two registrations would be completely independent and e.g. would end up in different UPFs, DNs, slices, etc. For example, the UE may use a first subscription for a first network and/or the UE may use a second subscription for a second network. While this may prevent the first network from removing registration of the UE, when the UE performs registration to the second network, the data exchange in the first network may not be harmonized with the data exchanges in the second network. For example, a first IP address supported by the first subscription may be different from a second IP address supported by the second subscription. This may not properly support MA-PDU session, if the QoS allowed for the first subscription is different from the QoS allowed for the second subscription. And it would not enable using multiple registrations for enhancing reliability and/or data rate increase.

In an example in this disclosure, a UE may indicate whether the UE supports a secondary registration, whether a registration procedure is for a primary registration, whether a registration procedure is for the secondary registration, and/or the like. This may assist a network to determine whether the network sends information of secondary networks to the UE or not. The information of second networks may assist the UE to determine a target network among one or more detected networks, to perform the second registration. This may reduce unnecessary signaling toward a network not supporting the secondary registration. In another example, a data management node may receive information of the secondary networks from a policy decision node and/or a steering management node. This may assist a mobility management node to deliver relevant information to the UE. In other embodiment, a home network may send information of one or more compatible networks for using one or more resources (e.g., radio access technologies, radio access networks, core networks, networks) for the UE. This may assist the UE in determining whether to request the second registration or not. This may reduce congestion in the signalling exchange. In another example, a radio access node may send information of whether a network support the secondary registration or not. This may help in reducing signalling message between the UE and the network.

In the specification, the term “5G access network” may be interpreted as, or may refer to, an access network comprising at least one of a NG-RAN and/or non-3GPP AN, and connecting to a 5G core network.

In the specification, the term “5G core network” may be interpreted as, or may refer to, a core network connecting to a 5G access network. This may be 5G core (5GC).

In the specification, the term “3GPP RAN” may be interpreted as, or may refer to, a radio access network using 3GPP RAT. For example, this may comprise at least one a gNB, an eNB, a ng-eNB, an en-gNB, the like, and/or a combination thereof. For example, this may be at least one of an E-UTRAN, NG-RAN, the like, and/or a combination thereof.

In the specification, the term “3GPP RAT” may be interpreted as, or may refer to, a radio access technology based on 3^{rd} generation partnership (3GPP) project. For example, this may comprise at least one of a NR, a E-UTRA, UTRA, GSM, the like, and/or a combination thereof.

In the specification, the term “N3GPP RAN” may be interpreted as, or may refer to, an access network using non-3GPP (N3GPP) RAT. This may be N3GPP access network (AN). For example, this may comprise at least one of N3IWF, ePDG, TNGF, W-GAN, the like, and/or a combination thereof.

In the specification, the term “network node” may be interpreted as, or may refer to, at least one of a core network node, an access node, a UE, the like, and/or a combination thereof. A network may comprise one or more network nodes.

In the specification, the term “3GPP access node” may be interpreted as, or may refer to, an access node using a 3GPP RAT. For example, this may comprise at least one a gNB, an eNB, a ng-eNB, an en-gNB, the like, and/or a combination thereof.

In the specification, the term “N3GPP access node” may be interpreted as an access node using a N3GPP RAT. For example, this may comprise at least one of N3IWF, ePDG, TNGF, W-GAN, the like, and/or a combination thereof.

In the specification, the term “N3GPP RAT” may be interpreted as, or may refer to, a radio access technology not based on 3^{rd} generation partnership project. This may be an access technology not developed by 3GPP. For example, this may comprise a WiFi, trusted WiFi, non-trusted WiFi, fixed access, wireline broadband, the like, and/or a combination thereof.

In the specification, the term “access type” may be interpreted as, or may refer to, indicating a type of access used for communicating with a network. For example, this may comprise a 3GPP access type (or 3GPP access) and/or a N3GPP access type (or N3GPP access). For example, if the access type is the 3GPP access type, this may indicate that a UE is communicating with the network by using one or more 3GPP RATs, and/or via one or more 3GPP RANs. For example, if the access type is the N3GPP access type, this may indicate that a UE is communicating with the network by using one or more N3GPP RATs, and/or via one or more N3GPP RANs. In an example, access may comprise at least one of sending a data, receiving a data, sending a signalling message, receiving a signalling message, performing registration, and/or the like.

In the specification, the term “3GPP access type” may be interpreted as, or may refer to, an access using one or more 3GPP RATs, and/or via one or more 3GPP RANs.

In the specification, the term “N3GPP access type” may be interpreted as, or may refer to, an access using one or more N3GPP RATs, and/or via one or more N3GPP RANs.

In the specification, the term “MA PDU Session” may be interpreted as a PDU Session that provides a PDU connectivity service, which can use/establish one access type at a time, or simultaneously one 3GPP access and one N3GPP access, simultaneously more than one paths of 3GPP access type or simultaneously more than one paths of N3GPP access type.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “RAT type” may be interpreted as, or may refer to, identifying the transmission technology used in the access network for 3GPP accesses and/or for non-3GPP accesses. For example, RAT type for 3GPP access may comprise at least one of NR, NB-IOT, E-UTRA, and/or the like. For example, RAT type for non-3GPP access may comprise at least one of untrusted non-3GPP, trusted non-3GPP, trusted IEEE 802.11 non-3GPP access, Wireline, Wireline-Cable, Wireline-BBF, WiFi, etc.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW-C, a SMF+PGW-U, a UDM+HSS and/or the like.

In the specification, the term “network system” may be interpreted as, or may refer to, a communication system, and/or a generation of the communication system. For example, one or more network systems may comprise an EPS, a 5GS. For example, the first network system may be the EPS. The EPS may comprise of one or more UEs, one or more eNB, one or more en-gNBs, one or more EPCs. The one or more EPCs may comprise a MME, a SGW, a PGW, and/or the like. For example, the second network system may be the 5GS. The 5GS may comprise of one or more UEs, one or more gNB, one or more ng-eNBs, one or more 5G core networks. The one or more 5G core networks may comprise an AMF, a SMF, a PCF, and/or the like.

In the specification, the term “5G System” may be interpreted as, or may refer to, a 3GPP system consisting of at least one of 5G access network (or NG-RAN), 5G core network and/or a UE.

In the specification, the term “EPS” may be interpreted as, or may refer to, a 3GPP system consisting of at least one of EPC, E-UTRAN and/or a UE.

In the specification, the term “access path” may be interpreted as, or may refer to, a path between a UE and a network for exchange of data and/or signalling. The access path may be an access leg, a path, an access route (route), an access track (track), an access channel (channel), an access corridor (corridor), and/or the like. The access path may indicate (be associated with) at least one of a path from a UE to a RAN, a path from a UE to a core network, a path from a RAN to a core network, the like, and/or a combination thereof. For example, the access path may be defined per a pair of a core network and/or an access network. For example, a path for a data between an access node and a core network may not be an access path if the access node and the core network may not be able to exchange a control signalling. For example, if a secondary node of a NG-RAN cannot exchange signalling messages with an AMF, the path between the secondary node of the NG-RAN to a core network may not be an access path. In an example, one or more access paths may be defined for an access type. The one or more access paths may be established for the access type. In other example, an access path may be associated with one or more core networks (e.g., roaming networks, visiting network, home network, anchor networks) and/or an access network.

For example, for each access type, there may be one or more access paths. For example, the one or more access paths may be used to transport signalling message for the access type. For example, there may be one or more (established, active) access paths (of signalling, of control message delivery) between the UE and the core network (e.g., AMF, SMF, PCF). For an access path, there may be an associated control plane connection. For example, for a UE, an AMF may be able to exchange a control message with a first gNB and/or a UPF may exchange data with the first gNB and/or the second gNB. In this case, the UE may be considered as having one path. For example, the link via the first gNB may be an access path, because the first gNB may be able to exchange control plane signalling with the AMF (and/or an SMF). For example, the link via the second gNB may not be considered as a path, because the AMF and the second gNB may not be able to exchange control plane signalling.

For example, the access path may comprise at least a control plane. For example, the access path may or may not have a user plane. Before establishing a bearer transporting user data (e.g., voice data, IP packets), the access path may not have the user plane. After establishing the bearer, the access path may have the user plane.

For example, using the example of FIG. 20, one or more access paths may comprise:
a path from the UE via the NG-RAN over GEO satellite and to a 3GPP core.
a path from the UE via the NG-RAN over LEO satellite and to a 3GPP core.
a path from the UE via the NG-RAN over Terrestrial (gNB) and to a 3GPP core.
a path from the UE via the NG-RAN over Terrestrial (eNB) and to a 3GPP core.
a path from the UE via the NG-RAN via a first 3GPP core (e.g., a first AMF) to a second 3GPP core (e.g., a second AMF).

For example, a UE may have one or more 3GPP access paths. The one or more 3GPP access paths may be defined/established/associated for 3GPP access type. Each 3GPP access path of the one or more 3GPP access path may support delivery of a control message (e.g., registration request message, PDU session establishment request message, and/or the like) and/or a control message (e.g., Initial UE message, N2 message, and/or the like) for a 3GPP access node. For example, the one or more 3GPP access path may comprise at least one of:
one or more first-type 3GPP access paths: A first-type 3GPP access path may be a route associated with a UE, a NG-RAN, a core network.
one or more second-type 3GPP access paths: A second-type 3GPP access path may be a route associated with a UE, a E-UTRAN, a core network.

For example, a UE may have one or more N3GPP access paths. The one or more N3GPP access paths may be defined/established/associated for N3GPP access type. Each N3GPP access path of the one or more N3GPP access path may support delivery of a control message (e.g., registration request message, PDU session establishment request message, and/or the like) and/or a control message (e.g., Initial UE message, N2 message, and/or the like) for a N3GPP access node. For example, the one or more N3GPP access path may comprise at least one of:
one or more first-type N3GPP access paths: A first-type N3GPP access path may be a route associated with a UE, a N3IWF, a core network.
one or more second-type N3GPP access paths: A second-type N3GPP access path may be a route associated with a UE, an ePDG, a core network.
one or more third-type N3GPP access paths: A third-type N3GPP access path may be a route associated with a UE, an TNGF (trusted Non-3GPP gateway function), a core network.
one or more fourth-type N3GPP access paths: A fourth-type N3GPP access path may be a route associated with a UE, an W-AGF (wireline access gateway function), a core network.

In the specification, the term “home network” may be interpreted as, or may refer to, a network which has a subscription of a UE. For example, the UE may subscribe to a service of the home network. For example, the UE may have a service agreement with the home network. For example, within the coverage of the home network, the UE may access the home network via using one or more RANs of the home network and/or one or more core network nodes of the home network. For example, outside of coverage of the home network, the UE may use one or more RANs of the visited network(s) and/or one or more core network nodes of the visited (roaming) network(s). For example, the UE may use one or more RANs of the visited network(s), one or more RANs of the home network, one or more core network nodes of the home network, and/or one or more core network nodes of the visited (roaming) network(s). Based on the subscription of the UE and/or based on service agreement between the home network and/or the visited network(s), the visited network(s) may determine whether to allow the UE of the home network to use the resources of the one or more RANs of the visited network(s) and/or the resources of the one or more core network nodes of the visited network(s). Based on the resources used for the UE, the visited (visiting) network(s) may send charging records to the home network. The subscription of the UE to the home network may allow the UE to use resources of the visited network(s) when the UE does not have subscription to the visited network(s).

In the specification, the term “secondary registration” may be interpreted as, or may refer to, registration to a second (or slave, secondary, controlled, and/or the like) network while registered to a first (or master, primary, controlling, prime and/or the like) network. For example, after power-on and/or when the UE is not registered to any network, a UE may perform a first (initial) registration toward the first network. To add additional resources, to add reliability, to increase data rate, and/or the like, the UE may perform the secondary (or additional, dual, multiple, concurrent, simultaneous, back-up, and/or the like) registration to the second network. For example, when the UE performs the secondary registration to the second network, the first network may not remove (delete, cancel, and/or the like) registration of the UE to the first network. E.g., in this case, the UE may remain registered to the second network, and/or may remain registered to the first network. For example, when the UE performs non-secondary registration (e.g., normal registration, registration not for secondary) to the second network, the first network may remove (delete, cancel, and/or the like) registration of the UE to the first network. E.g., in this case, the UE may remain registered to the second network, and/or may not remain registered to the first network

In the specification, the term “primary network” may be interpreted as, or may refer to, a network for which the UE keeps a primary registration. For example, a network for a first (initial, elementary) registration of the UE after power-on may be the primary network. For example, when the UE is not registered to any network, a network for a first registration of the UE may be the primary network. For example, when a UE is registered to only one network, the only one network may be the primary network. For example, the primary network may determine one or more networks for a secondary registration. For example, the primary network may determine whether to use/allow another network(s) as the secondary network. For example, the primary network may manage context information for a UE, may determine configuration used in the secondary network, may determine whether to use the second network, may determine to deactivate use of the secondary network, and/or may deliver part of the context information to the secondary network.

In the specification, the term “secondary network” may be interpreted as, or may refer to, a network for which the UE perform a secondary registration. For example, after the UE registers to a primary network, the UE may perform additional registration toward another network, while the UE is registered to the primary network. The another network may be the secondary network. When the UE is registered to the secondary network, the UE may be registered to the primary network. For example, the secondary network may have a service agreement with the primary network. For example, a mobility management node of the secondary network may communicate with a mobility management node of the primary network. For example, the UE may be allowed to register to and/or may be allowed to be registered to the secondary network, while the UE is registered to the primary network. For example, registration to the secondary network may not lead to deregistration of the UE in the primary network. For example, for the configuration of the UE in the secondary network, the secondary network may contact the primary network to get assistant information for the configuration.

In the specification, the term “support of secondary network” may be interpreted as, or may refer to, whether a node supports handling/processing one or more information associated with a secondary network. For example, if a first network supports the feature of the secondary network, the first network may be able to exchange data with a second network (corresponds to the secondary network), to configure a UE with information associated with the second network, to perform as the primary network, to process the information associated with the secondary network, to act as a primary network, and/or the like. For example, if the second network supports the feature of the secondary network, the second network may be able to exchange data with the first network (corresponds to the primary network), to configure a UE with information associated with the secondary network, to perform as the secondary network, to process the information associated with the secondary network, and/or the like. Similarly, if a UE can process/handle one or more information associated with the primary network and/or the secondary network, the UE may support the feature of the secondary network. To support the feature of the secondary network may be to support the feature of the secondary registration, to support the feature of the primary registration, and/or the like. It is to be noted that support for secondary network may indicate that an association exists or will be established between a first registration to a first network and a secondary registration to a second network. Hence, if a UE supports multiple USIMs and a secondary registration to a second network would be completely independent from a first registration, then such UE may not indicate support for the feature “support of secondary network”.

In the specification, the term “mobility management node” may be interpreted as, or may refer to, a function and/or a node performing mobility management for a UE. For example, mobility management may be at least one of management of registration status, management of context, management of authorization, management of registration area, management of paging, and/or the like. For example, the mobility management node may comprise at least one of a MME, AMF, and/or the like.

In the specification, the term “allowed network” may be interpreted as, or may refer to, one or more networks for which the UE is allowed for a secondary registration. For example, after registering to a primary network, the UE may be allowed to perform the secondary registration to the allowed network. The allowed network may comprise one or more networks to which the UE is allowed to perform the secondary registration. For example, the UE may not be allowed to perform secondary registration to a network which is not the allowed network. The allowed network may be one or more allowed networks for the secondary registration. The allowed network may be a network selected by the UE to perform the secondary registration.

In an example, a UE may send a first registration request message to a first network. For example, the first registration may request one or more requested network slices. For example, the one or more requested network slices may indicate a first network slice, a second network slice, and/or a third network slice. The first network may not support some of the one or more requested network slices. For example, due to service restriction or resource shortage, the first network may reject the first network slice and/or the second network slice. For example, the first network may send a first registration accept message indicating that the first network slice and/or the second network slice is rejected, that the third network slice is accepted, and/or that a network K may support the first network slice and/or that a network N may support the second network slice. This may lead to unpredictable behavior of the UE. For example, if the UE needs both the first network slice and the second network slice, the UE may not be able to determine whether to select the network N or the network K, leading to extended service interruption time. For example, if the UE needs both the first network slice and the third network slice, the UE may not be able to determine whether to perform de-registration of the third network slice, and to select the network K, leading to unnecessary registration. Or, if the UE selects the network N, whenever data is generated for the second network slice, the UE may switch back and forth between the network K and the network N. This may cause ping-pong, and may make connectivity unstable, and may not properly support MA-PDU session. Thus, selecting a network associated with a rejected network slice may not enhance system performance.

In another example, the UE may use one or more subscriptions. For example, the UE may use a first subscription for a first network and/or the UE may use a second subscription for a second network. While this may prevent the first network from removing registration of the UE, when the UE performs registration to the second network, the data exchange in the first network may not be harmonized with the data exchanges in the second network. For example, a first IP address supported by the first subscription may be different from a second IP address supported by the second subscription. This may not properly support MA-PDU session, if the QoS allowed for the first subscription is different from the QoS allowed for the second subscription.

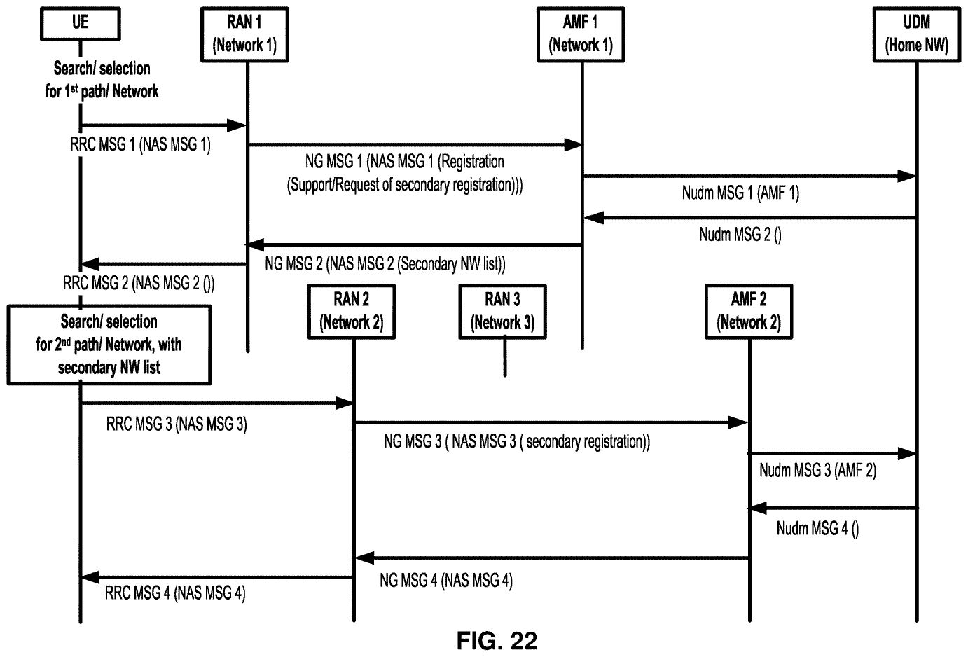

FIG. 22 may depict one example embodiment of the present disclosure. In an example, a UE may perform a first registration to a first network via a first access path (e.g., a path from UE via RAN 1 via AMF 1), may receive a list of secondary networks, may select a network in the list of the secondary networks, and/or may perform a secondary registration to the network. This may reduce a time for the UE to access a certain network which supports provision of multi-network service and/or the secondary registration. For brevity, based on the other part of the present disclosure, redundant details will be omitted.

In an example, the UE may search and/or select the first network. For example, the UE may search one or more networks, one or more cells of the one or more networks. The one or more cells may use one or more 3GPP RATs, may be part of one or more 3GPP RANs, and/or may use 3GPP access type. The UE may select a cell (e.g., a first cell) from the one or more cells, and/or may determine to use the cell for a first access path. The first access path may be a 3GPP access path, and/or may be associated with the 3GPP access type. For example, the first access path may use the first 3GPP RAN, and/or may be established in the first network. For example, the UE may select the first network, after the UE is switched on, when the UE perform network reselection and/or when the UE is not registered. For example, the UE may determine to perform a first registration to the first network. For example, the first network may be a home network, or a (first) visited network. For example, the first registration may be a primary registration.

In an example, the UE may support a feature of secondary registration. The feature of secondary registration may be at least one of establishing (for example, registering, using) one or more access paths via one or more networks, establishing (for example, registering, using) the one or more access paths of an access type, exchanging one or more control messages associated with a secondary network via a primary network, identifying one or more registrations via one or more networks, performing the primary registration, performing the secondary registration, performing (for example, handling) multiple registrations toward one or more networks, and/or the like.

In an example, to perform the first registration, the UE may send a first NAS message (e.g., NAS MSG 1) to a first mobility management node of the first network. For example, the UE may send the first NAS message via the first access path. For example, the UE may use a first subscription for the registration to the first network. For example, the first NAS message may be at least one of a registration request message, a service request message, an attach request, and/or the like. For example, the first NAS message may indicate that the UE supports the feature of the secondary registration, that the UE requests a primary registration, that the UE requests information of one or more candidates for a secondary network, that the UE requests a service from a network supporting (or can exchange a signalling with) a secondary network, and/or the like. For example, the first mobility management node may be a first AMF, a first MME, and/or the like.

In an example, the first access path may involve a first RAN (e.g., a first 3GPP RAN). If the UE supports the feature of the secondary registration, while the UE is registered for the primary registration (e.g., registration with the primary network), the UE may be able to send a second NAS message via a second (for example, 3GPP) access path (of the secondary network). If the UE supports the feature of the secondary registration, when the UE performs the secondary registration (for example, via the second 3GPP RAN and/or via the secondary network) while registered to the first registration (via the first 3GPP RAN), the UE may not overwrite/cancel/delete/remove the first registration and/or may keep the primary registration via the first access path (or the primary network). If the UE supports the feature of the secondary registration, the UE may be able to exchange one or more NAS messages with a first core network (of the first network) via using the first access path, or with a second core network (of the second network) via using the second access path, and/or a combination thereof. Similarly, one or more network nodes may support the feature of secondary registration, if the one or more network nodes is able to use/establish/identify/ differentiate the secondary (e.g., second) registration from primary (e.g., first) registration.

In an example, after searching and/or selecting the first cell for the first network, the UE may determine that the first network (e.g., used as the primary network) is to be used for primary registration (connection).

In an example, the UE may construct the first NAS message (e.g., NAS MSG 1). The first NAS message may comprise at least one of an identifier (e.g., IMSI, SUPI, SUCI, GUTI, and/or the like) of the UE, a 5GS registration type, a preferred network behavior, last visited registered TAI, PDU session status, EPS NAS message container, payload container, 5GMM capability, requested NSSAI, and/or the like. The identifier of the UE may indicate an identity of the UE. The 5GS registration type may indicate a type of the requested registration. For example, the 5GS registration type may be at least one of initial registration, mobility registration updating, periodic registration updating, emergency registration, SNPN onboarding registration, disaster roaming mobility registration updating, disaster roaming initial registration, initial registration for multiple networks, primary registration, and/or the like. For example, the initial registration for multiple networks and/or the primary registration may indicate that the UE performs the first (initial, main, primary, and/or the like) registration (e.g., not secondary registration) to the first network. For example, the first NAS message may comprise the 5GS registration type set to the primary registration. For example, the preferred network behavior may indicate one or more features that the UE requests the network to support. For example, if the UE wants the network to support the feature of secondary registration, the preferred network behavior may be set to support of the feature of secondary (e.g., multiple) registration.

In an example, the UE may send a first RRC message (e.g., RRC MSG 1) to a first 3GPP RAN (e.g., 3GPP RAN 1). For example, the first 3GPP RAN may comprise at least one of a first gNB, a first ng-eNB, a first eNB, a first en-gNB, and/or the like. For example, the first RRC message may be at least one of a RRC setup request message, a RRC setup complete message, a RRC resume request message, a RRC resume complete message, a RRC UL transfer message, and/or the like. For example, the first RRC message may comprise at least one of the first NAS message, RRC establishment cause, and/or the like. The RRC establishment cause may indicate that the RRC connection is to establish the first access path, and/or to perform the primary registration. The first 3GPP RAN may receive the first RRC message via the first cell of the first 3GPP RAN.

In an example, the first 3GPP RAN may send a first NG message to the first AMF. The first NG message may be at least one of an initial UE message, an uplink NAS transport, and/or the like. The first NG message may comprise at least one of an identifier (e.g., a gNB ID, a TAI, a cell ID, a 3GPP access RAN type, a RAT type) of the first 3GPP RAN (and/or the first cell), the first NAS message, user location information, the RRC establishment cause. For example, the 3GPP access RAN type may indicate whether the first 3GPP RAN is NG-RAN, satellite NG-RAN, E-UTRAN and/or the like.

In an example, the first AMF may receive the first NG message. Based on the first NAS message of the first NG message, the AMF may determine whether the UE requests the first network to support the feature of the secondary registration and/or whether the first NAS message is for the primary registration. For example, if the first NAS message comprises the 5GS registration type set to the primary registration, the AMF may determine that the UE requests at least one of support (or service) of the multiple registration, (the feature of) the secondary registration, and/or the primary registration.

In an example, if the first AMF determines that the UE requests support of the feature of the secondary registration, that the registration request is for the primary registration, that the UE requests registration, and/or that the UE supports the feature of the secondary registration, the first AMF may send a first Nudm message (e.g., Nudm MSG 1) to a data management node (e.g., UDM) of a home network. For example, the first Ndum message may be at least one of Nudm_UECM_Registration request message, Nudm_UECM_Get request message, Nudm_UECM_Update request message, Nudm_SDM_Get request message, Nudm_SDM_Subscribe request message, and/or the like. The first Nudm message may comprise at least one of an identifier of the first AMF, a SUPI of the UE, a GUTI of the UE, an access type, a GUAMI, a RAT type, a registration type (e.g., indicating the primary registration), the first access path identifier, a location (e.g., cell ID, TA ID associated with the first 3GPP RAN) of the UE, an information (e.g., identifier) of the first 3GPP RAN, an information (e.g., identifier) of the first network, an indication of primary registration, and/or the like. For example, the GUAMI may comprise a MNC and/or a MNC of a serving (e.g., the first) network (e.g., PLMN, an NPN, an SNPN) of the UE. For example, the UDM may be a data management node. For example, the UDM may be located in the home network of the UE. For example, the access type may indicate whether the registration associated with the first Nudm message is for a 3GPP access or for a N3GPP access. For example, the access type of the first Nudm message may be set to the 3GPP access. For example, the registration type may be the 5GS registration type of the first NAS message. For example, the indication of primary registration may indicate whether the first network serves the primary connection, whether the first AMF (and/or the first network, the first RAN, first access path) is used for primary connection (registration).

In an example, the UDM may receive the first Nudm message. In response to receiving the first Nudm message, the UDM may store information delivered via the first Nudm message, into its memory (or its storage). In response to the first Nudm message, the UDM may send a second Nudm message (Nudm MSG 2). For example, the second Nudm message may be at least one of Nudm_UECM_Registration response message, Nudm_UECM_Get response message, Nudm_UECM_Update response message, Nudm_SDM_Get response message, Nudm_SDM_Subscribe response message, and/or the like. For example, the second Nudm message may comprise at least one of a result indication, the identifier of the first AMF, the access type used for the first access path, the first access path identifier, a subscription data, the indication of primary connection, and/or the like. For example, the result indication may indicate whether the first Nudm request is processed successfully or not. For example, if the UDM supports the feature of secondary registration, and/or if the UDM allows the UE (or the AMF) to use the feature of the secondary registration, the result indication may indicate that the first Nudm request is successfully processed. For example, if the UDM does not support the feature of the secondary (for example, multiple registration, the first registration, the primary registration), if the UDM does not allow the first network to be the primary network, and/or if the UDM does not allow the UE (or the AMF) to use the feature of the secondary registration, the result indication may indicate that the first Nudm request is not successfully processed and/or that secondary registration (or multiple registration, the primary registration) is not allowed for the UE. For example, the result indication of the second Nudm message may indicate a success. For example, the subscription data of the second Nudm message may indicate that the UE is allowed to use the feature of the secondary registration. The subscription data in the second Nudm message and/or stored in the UDM (or in a related UDR) and based on which the second Nudm message is constructed may comprise at least one of an information of whether the UE is allowed to use the feature of the secondary (e.g., using multiple) registration, an information of whether the UE is allowed to use MA PDU session, and/or an information of whether the UE is allowed to register over the primary network and over the secondary network. The UDM may operate two subscriptions and/or two SUPIs for the same UE, whereby the two subscriptions may be linked and/or indicate support dual registration/dual connectivity over two different networks. For example, the subscription data of the second Nudm message may indicate that the UE is allowed to use the feature of the secondary registration.

In an example, the first AMF may receive the second Nudm message. Based on the second Nudm message, the first AMF may determine whether to accept the registration of the UE and/or whether to allow the primary registration, whether to send a list of the secondary networks. For example, if the subscription data of the second Nudm message indicates that the UE is allowed to use the feature of secondary registration, the first AMF may determine to allow the first (e.g., the primary) registration. For example, if the result indication of the second Nudm message indicates the success, the first AMF may determine to allow the first registration of the UE. Based on the determination to allow the first registration, the first AMF may store the information received via the first NAS message and/or via the first Nudm message. For example, the first AMF may manage a first context for the UE. For example, the first context may be associated with the first access leg (or path) of the UE, the first AMF, the primary registration, a master (or primary) security context (e.g., Kamf, Kgnb, ciphering key, integrity key) and/or the first network.

In an example, the first AMF may determine to send a second NAS message (e.g., NAS MSG 2) to the UE. For example, the second NAS message may be at least one of a registration accept message, a service accept message, a DL NAS transport message, a PDU session establishment accept message, a UE configuration update (configuration update command) message, a PDU session modification command message, and/or the like. The second NAS message may comprise at least one of a 5GS registration result, a 5G-GUTI, the first access path identifier, a TAI list, an allowed NSSAI, a 5GS network feature support, and/or the like. The 5G-GUTI may indicate an assigned 5G-GUTI by the first network (or the first AMF) to the UE. The TAI list may indicate assigned TAI list to the UE for the first access path. The Allowed NSSAI may indicate one or more allowed network slices for the UE. The 5GS network feature support may indicate whether the network supports the feature of secondary registration. For example, the 5GS network feature support may indicate that the feature of the secondary registration is supported by the first network (the first AMF, a SMF, and/or the like). For example, the 5GS network feature support may indicate that the first network is the primary network, that the first AMF is the primary AMF, that feature of the secondary registration is supported by the first network (the first AMF, a SMF, and/or the like). For example, the list of secondary networks (e.g., secondary Network list) may indicate one or more secondary networks that the UE is allowed to select for performing the secondary registration. For example, the list of secondary networks may indicate which networks are candidates for the secondary registration, when the UE is primary registered to the first network. For example, the list of the secondary networks may comprise one or more identifiers of the potential/candidate/allowed secondary networks which may be used with the primary network.

In an example, the list of secondary networks may further comprise condition information. For example, the condition information may indicate at least of one of one or more frequency bands, one or more radio access network types, and/or one or more RATs allowed for the secondary registration, a time duration, a location area, for each of the one or more secondary networks. For example, if the list of secondary information indicates that FR1, satellite RAN for a network 6, the UE may perform the secondary registration with the network 6, if a cell of network 6 uses FR1, the satellite RAN, and/or the like. For example, the list of secondary networks may comprise one or more identifiers (e.g., PLMN ID, SNPN ID, CAG ID, and/or the like) of the one or more secondary networks.

In an example, the AMF may send a second NG message (e.g., NG MSG 2) to the first 3GPP RAN. For example, the second NG message may be at least one of initial context setup request message, a UE context modification request message, a downlink NAS transport message, a path switch response message, a path switch, and/or the like. The second NG message may comprise at least one of an AMF UE NGAP ID, the GUAMI, the first access path identifier, indication of primary connection, PDU session resource setup request list, UE radio capability, mobility restriction list, NAS PDU, and/or the like. For example, the NAS PDU may be the second NAS message.

In an example, the first 3GPP RAN may receive the second NG message. The first 3GPP RAN may store information delivered via the second NG message and/or may send a second RRC message (e.g., RRC MSG 2) to the UE. For example, the second RRC message may comprise the second NAS message of the second NG message.

In an example, the UE may receive the second RRC message and/or the second NAS message. The UE may determine whether the first registration (e.g., the primary registration, registration to the first network, registration to the primary network) is successful or not. For example, if the second NAS message indicates successful registration, registration accept, support of the feature of the secondary registration, and/or the like, the UE may determine that the first (e.g., primary) registration is successful, that the UE is allowed for performing the secondary registration, and/or that the registration is successful.

In an example, based on the determination, the UE may determine to perform the secondary registration. For example, the UE may search one or more second networks, one or more second cells of the one or more second networks. The one or more second cells may use one or more 3GPP RATs, may be part of one or more 3GPP RANs, and/or may be part of a 3GPP access type. For example, the one or more second cells may belong to the second 3GPP RAN (e.g., 3GPP RAN 2) and/or may belong to a second network in the list of the secondary networks. For example, the UE may select a second cell of the one or more second cells. The second cell may be used for a second access path of a 3GPP access, and/or may be associated with the 3GPP access type. For example, the second cell and/or the second 3GPP RAN (e.g., using FR2 band, using satellite, and/or the like) may be different from the first cell and/or the first 3GPP RAN (e.g., using FR1 band, using terrestrial, and/or the like). For example, the second network may be an allowed network for the secondary registration and/or may be in the list of the secondary networks. For example, the second network may be a network that is allowed for the secondary registration with the first (e.g., the primary) network.

In other example, based on the determination, the UE may determine whether to perform the secondary registration. For example, the UE may detect one or more third networks, one or more third cells of the one or more third networks. The one or more third cells may use one or more 3GPP RATs, may be part of one or more 3GPP RANs, and/or may be part of a 3GPP access type. For example, the one or more third cells may belong to the third 3GPP RAN (e.g., 3GPP RAN 3) and/or may belong to a third network. The third network may not be in the list of the secondary networks. For example, because a third cell of the one or more third cells are not in the list of the secondary networks, the UE may not select the third cell of the one or more third cells. For example, the third network may not be an allowed network for the secondary registration. For example, the third network may not be a network that is allowed for the secondary registration with the first (e.g., the primary) network. The UE may not select the third cell and/or the UE may not perform the secondary registration toward the third cell and/or the third network.

In another example, the AMF or RAN may send as part of the second NAS message or as part of an intermediate RRC or NAS message (e.g. before/after the second NAS message) a request for the UE to provide a list of discovered networks (e.g. Cell IDs and/or PLMN IDs of the networks from which the UE received SIB information) and/or to provide information on which networks in the list of secondary networks (that may be provided by the AMF or RAN to the UE) are available to the UE (e.g. can be discovered by the UE), possibly together with measurement information (e.g. signal quality, signal strength) of the discovered networks, and/or provide location information of the UE (e.g. GNSS position). The UE may respond to such request by transmitting an/another intermediate RRC or NAS message (e.g. before sending the third NAS message as described below) containing one or more of the requested information. Based on the information provided by the UE, the network (e.g. RAN, AMF, SoR-AF) can determine a subset of the list of (preferred) secondary networks and/or select the (preferred) secondary network that the UE needs to register with from a list of candidate secondary networks, and/or determine an additional network to be added to the list of secondary networks, and based on this determination send an updated list with candidate networks (possibly including the rules/conditions to access them) in a response (e.g. the second message or another intermediate message) to the UE. Based on the response received from the network, the UE may determine whether to perform the secondary registration and/or may determine which second network to use/search for to perform the secondary registration. Additionally or alternatively, the network function that received the information related to which networks the UE has discovered and/or measurements related to the discovered networks may forward this information or summary/subset thereof and/or provide the determined subset of the list of (preferred) secondary networks and/or the selected (preferred) secondary network to one or more of the discovered networks (e.g. by the AMF of the first network communicating with the AMF of a discovered network, or by a NF of the first network communicating via NEF or SBI with a NF of the second network). Additionally or alternatively, a network function of the first network (e.g. AMF) to which a UE is registered may provide information about that UE to one or more other networks (e.g. a set of identifiers related to that UE (e.g. a list of SUPIs of one or more subscriptions of that UE), PDU session ID used by the UE for communicating with the first network or a related ID (e.g. an identifier to indicate/correlate multiple PDU sessions from a UE over a first and/or second network), a set of network slices that a UE is using or is allowed or not allowed to use for a secondary registration, a list of capabilities of that UE (e.g. indicating support for dual registration and/or traffic splitting/switching/steering over two networks, list of supported frequency bands), a list of services that a UE may use over the primary and/or secondary connection), for example to one or more networks registered for dual connectivity/dual registration (e.g. secondary network linked to first and/or second subscription data for that UE in the UDM) and/or one or more networks for which information has been provided by the UE that they have been discovered by the UE. This enables the discovered networks to prepare for incoming connection from the UE for secondary registration. For example, based on the information received from the first network, a second network may add/remove one or more slices to/from the allowed slice list for the UE, update RAN policies, reserve/schedule some resources for the UE, perform beamsteering of one or more cells towards the UE location, transmit (e.g. by broadcasting an (updated) SIB) to one or more UEs (e.g. by a cell in vicinity of the UE, for example based on UE location information and/or cell ID received from the first network)) some information such as information about the first network registration of the UE (e.g. network ID of the first network) or about one or more candidate second networks for the UE to register to.

In an example, after searching and/or selecting the second cell (of the second 3GPP RAN, of the second network), the UE may construct a third NAS message (e.g., NAS MSG 3). The third NAS message may be at least one of a registration request message, a service request message, a UL NAS transport message, a deregistration request message, a PDU session establishment request message, a PDU session modification request message, a PDU session release request message, and/or the like. The third NAS message may comprise at least one of an identifier (e.g., IMSI, SUPI, SUCI, GUTI, and/or the like) of the UE, a 5GS registration type, the preferred network behavior, the second access path identifier, a last visited registered TAI, PDU session status, EPS NAS message container, payload container, 5GMM capability, requested NSSAI, the second access path identifier, the access type, and/or the like. The identifier of the UE may be an identity of the UE. This may be a different identity than for used in the first NAS message for the first registration (e.g. SUCI based on a different SUPI than for the first registration). The network may link the two identities used in the first and second registration. The 5GS registration type of the third NAS message may indicate the secondary registration, the multiple registration, and/or the like. For example, the 5G registration type may indicate that the second registration (or the third NAS message) is for secondary registration, and/or an additional (subsequent and/or the like) registration after the primary registration. For example, the preferred network behavior may be set to the support of the feature of secondary registration. The preferred network behavior may assist a radio access node and/or a core network node to select a node which supports the preferred network behavior (e.g., secondary registration, multiple/additional registration).

In an example, the UE may send a third RRC message (e.g., RRC MSG 3) to the second 3GPP RAN (e.g., 3GPP RAN 2) of the second network. For example, the second 3GPP RAN may comprise at least one of a second gNB, a second ng-eNB, a second eNB, a second en-gNB, and/or the like. For example, the third RRC message may be at least one of a RRC setup request message, a RRC setup complete message, a RRC resume request message, a RRC resume complete message, a RRC UL transfer message, and/or the like. For example, the third RRC message may comprise at least one of the third NAS message, RRC establishment cause, and/or the like. The RRC establishment cause may indicate that the RRC connection is to establish the second access path and/or that the RRC connection is for the secondary registration. The second 3GPP RAN may receive the third RRC message via the second cell of the second 3GPP RAN of the second network.

In an example, the second 3GPP RAN may send a third NG message to a second mobility management node of the second network. For example, the second mobility management node may be a second AMF of the second network. For example, the second 3GPP RAN may determine to send the third NG message. The third NG message may be at least one of an initial UE message, an uplink NAS transport, and/or the like. The third NG message may comprise at least one of an identifier (e.g., a gNB ID, a TAI, a cell ID, a 3GPP access RAN type, a RAT type) of the second 3GPP RAN, the third NAS message, user location information, the RRC establishment cause, and/or the like.

In an example, the second AMF may receive the third NG message. Based on the third NAS message of the third NG message, the second AMF may determine whether the UE requests the secondary registration. For example, if the third NAS message comprises the 5GS registration type set to the secondary registration, the second AMF may determine that the UE requests secondary registration to the second network. For example, if the second AMF does not support the feature of secondary registration, the second AMF may reject the (second) registration request and/or the second AMF may request the first AMF and/or the UDM to cancel/release the first (e.g., primary) registration of the UE.

In an example, if the second AMF determines that the UE requests the secondary registration, and/or that the third NAS message is for the secondary (e.g., additional, multiple) registration, the second AMF may send a third Nudm message (e.g., Nudm MSG 3) to the UDM. For example, the third Ndum message may be at least one of a Nudm_UECM_Registration request message, a Nudm_UECM_Get request message, a Nudm_UECM_Update request message, a Nudm_SDM_Get request message, a Nudm SDM Subscribe request message, and/or the like. The third Nudm message may comprise at least one of an identifier of the second AMF, a SUPI of the UE, a GUTI (e.g., 5G GUTI, of used in the first network and/or in the second network) of the UE, the access type (e.g., 3GPP access type), a second GUAMI of the second AMF, a RAT type, a registration type (e.g., the secondary registration), a second access path identifier, a location (e.g., cell ID, TA ID associated with the second 3GPP RAN) of the UE, an indicator indicating that the second AMF (network) supports the secondary registration, an information (e.g., identifier) of the second 3GPP RAN and/or the like. For example, the registration type may be the 5GS registration type of the third NAS message.

In an example, the UDM may receive the third Nudm message. In response to receiving the third Nudm message, the UDM may store information delivered via the third Nudm message, into its memory (or its storage). For example, the UDM may store at least one of the identifier of the second AMF, the identifier of the second network, the indication of the secondary registration, that the second network is used for the secondary registration, and/or the like. In response to the third Nudm message, the UDM may send a fourth Nudm message (e.g., Nudm MSG 4). For example, the fourth Nudm message may be at least one of a Nudm_UECM_Registration response message, a Nudm_UECM_Get response message, a Nudm_UECM_Update response message, a Nudm_SDM_Get response message, a Nudm_SDM_Subscribe response message, and/or the like. For example, the fourth Nudm message may comprise at least one of a result indication, the identifier of the second AMF, the access type, the second access path identifier, the subscription data, and/or the like. For example, the result indication may indicate whether the third Nudm request is processed successfully or not. For example, if the UDM supports the feature of secondary registration, if the second network (or the second AMF) is allowed for the secondary registration for the UE, if the second network is allowed to be used in addition to the first network, and/or if the UDM allows the UE (or the second AMF) to use the feature of the secondary registration, the result indication may indicate that the third Nudm request is successfully processed. For example, if the UDM does not support the feature of secondary registration, if the second network is not allowed for secondary registration, if the first network does not support the secondary registration, if the second network does not support the secondary registration, if the second network is not allowed to be used with the first network, and/or if the UDM does not allow the UE (or the second AMF, the second network) to use the feature of the secondary network, the result indication may indicate at least one of that the third Nudm request is not successfully processed, that the third Nudm request is successfully processed without allowing the secondary registration, and/or the like. For example, the result indication of the fourth Nudm message may indicate a success. For example, the subscription data of the fourth Nudm message may indicate that the UE is allowed to use the feature of secondary registration, that the second AMF (network) is registered in the UDM, and/or that the UE is allowed to use the second (additional) access path of second network.

In an example, the second AMF may receive the fourth Nudm message. Based on the fourth Nudm message, the second AMF may determine whether to accept the second registration of the UE and/or whether to allow the registration of the second access path via the second network for the access type. For example, if the subscription data of the fourth Nudm message indicates that the UE is allowed to use the feature of secondary registration, the second AMF may determine to allow the secondary registration of the second access path and/or the second network. For example, if the result indication of the fourth Nudm message indicates the success, the second AMF may determine to allow the secondary registration of the second access path and/or the second network. Based on the determination to allow the registration of the second access path, the secondary registration and/or the second network, the second AMF may store the information received via the third NAS message and/or via the fourth Nudm message. For example, the second AMF may manage a second context for the UE. For example, the second context may be associated with the second access leg (path) of the UE, the second AMF, the secondary registration, a slave (secondary) security context (e.g., Kamf2, Kgnb2, ciphering key 2, integrity key 2) and/or the second network. For example, the slave security context may be relevant for the second network and the UE, and/or for the second access leg. For example, the slave security context may be derived from the master security context (which is in the first/primary network/AMF).

In an example, the second AMF may determine to send a fourth NAS message (e.g., NAS MSG 4) to the UE. For example, the fourth NAS message may be at least one of a registration accept message, a service accept message, a DL NAS transport message, a PDU session establishment accept message, a UE configuration update (configuration update command) message, a PDU session modification command message, and/or the like. The fourth NAS message may comprise at least one of a 5GS registration result, a 5G-GUTI, a TAI list, an allowed NSSAI, a 5GS network feature support, the second access path identifier, and/or the like. The 5G-GUTI may indicate an assigned 5G-GUTI to the UE, by the first network and/or by the second network. The TAI list may indicate assigned TAI list to the UE for the second access path. The 5GS registration result may indicate whether the (secondary) registration is successful or not.

In an example, the second AMF may send a fourth NG message (e.g., NG MSG 4) to the second 3GPP RAN. For example, the fourth NG message may be at least one of initial context setup request message, a UE context modification request message, a downlink NAS transport message, a path switch response message, and/or the like. The fourth NG message may comprise at least one of the AMF UE NGAP ID, the second GUAMI associated with the second AMF, the second access path identifier, PDU session resource setup request list, UE radio capability, mobility restriction list, NAS PDU, and/or the like. For example, the NAS PDU may be the fourth NAS message. For example, the UE radio capability may be a radio capability of the UE associated with the second access path. For example, the mobility restriction list may be associated with the second access path.

In an example, the second 3GPP RAN may receive the fourth NG message. The second 3GPP RAN may store information delivered via the fourth NG message and/or may send a fourth RRC message (e.g., RRC MSG 4) to the UE. For example, the fourth RRC message may comprise the fourth NAS message of the fourth NG message.

In an example, the UE may receive the fourth RRC message and/or the fourth NAS message. The UE may determine whether the secondary registration via the second access path is successful or not. For example, if the fourth NAS message indicates successful registration (of the second access path, multiple access paths of the access type, and/or the additional access path), registration accept, support of the feature of the secondary registration, successful secondary registration, the second access path identifier, and/or the like, the UE may determine that the secondary registration via the second network is successful, that the UE is registered for second access paths of the access type, that the UE is registered via the second access path, and/or that the secondary registration is successful. In an example, the access type of the second access path may be the access type of the first access path.

In an example, based on the primary registration via the first network and/or the secondary registration via the second network, the UE may continue to establish/update a MA PDU session by using the first access path of the 3GPP access type and/or the second access path of the 3GPP access type, with one or more SMFs.

The example shown in FIG. 22 may help for a UE to register more than one networks supporting multiple registration of 3GPP access type, while reducing unnecessary registration attempt to a non-supporting network. For example, this may support two independent 3GPP RANs (e.g., NG-RAN plus NG-RAN, NG-RAN plus E-UTRAN, and/or the like) to have NG-C connections to one or more core networks.

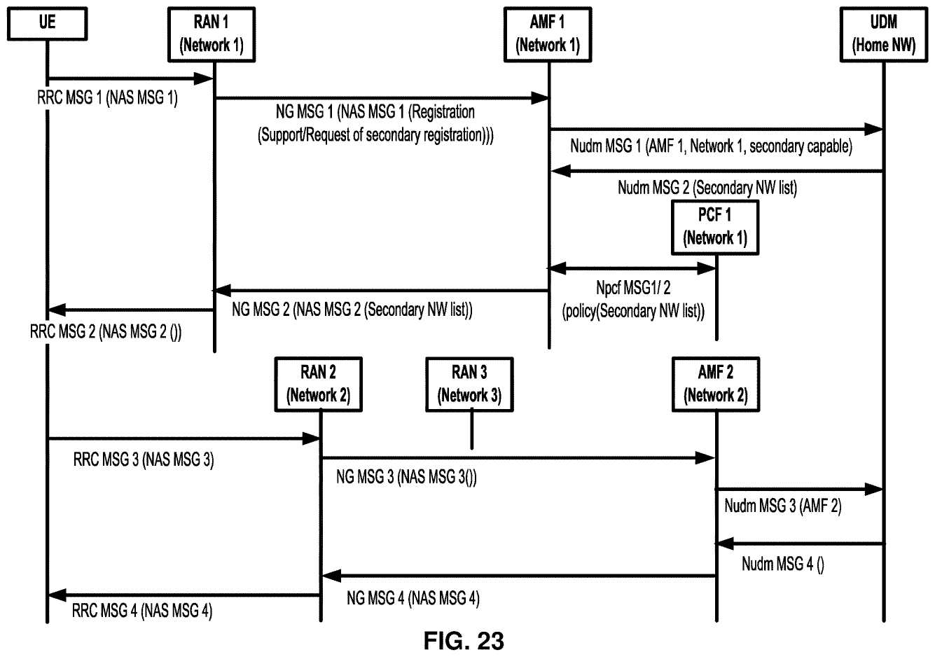

FIG. 23 may depict one example embodiment of the present disclosure. Similar to FIG. 22, the UE may perform the primary and/or the secondary registration, based on the list of the secondary networks. In the example of FIG. 23, the first AMF may receive assistant information from one or more network nodes. This may assist for the first AMF to determine the list. For brevity, based on the other part of the present disclosure, redundant details will be omitted.

In an example, the first AMF may receive from the UE, the first NAS message. In response to receiving the first NAS message, the first AMF may send the first Nudm message to the UDM. For example, the UDM may be in the home network of the UE. The first Nudm message may further comprise at least one of an indication of whether the first AMF supports the feature of the secondary registration, an indication that the first AMF is the primary network, an indication that the UE requests the primary registration, an indication that the first AMF request information on candidate (potential, allowed) secondary networks and/or the like. In response to receiving the first Nudm message, the UDM may send to the first AMF, the second Nudm message. Because the first Nudm message comprises the indication, the second Nudm message may further comprise information of the list of the secondary networks. For example, the UDM may have a stored information for the list of the secondary networks. For example, the operator may store the list of the secondary networks in the UDM. For example, using subscription information of the UE, and/or using service agreement between one or more networks, the operator may determine which networks can be used as a secondary network for which network. In an example, the first AMF may receive from the UDM, the second Nudm message comprising the list of the secondary networks.

In another example, the AMF may send a first Npcf message to a policy management node. For example, the policy management node may be a policy control function (PCF). For example, the first Npcf message may comprise at least one of a Npcf_AMPolicyControl_Create request message, Npcf_UEPolicyControl_Create request, and/or the like. The first Npcf message may comprise at least one of an identifier of the UE, the identifier of the first network, the capability of the UE (e.g., support for the feature of the secondary network), the indication of the primary registration, a request for the list of the secondary networks, and/or the like. In response to receiving the first Npcf message, the PCF may send to the first AMF, a second Npcf message. For example, the second Npcf message may comprise at least one of a Npcf_AMPolicyControl_Create response message, Npcf_UEPolicyControl_Create response, and/or the like. The second Npcf message may comprise the list of the secondary networks. For example, the PCF may have network policy information, and may be able to determine one or more networks allowed for the secondary registration. In an example, the first AMF may receive from the PCF, the second Npcf message comprising the list of the secondary networks.

In an example, the AMF may use the list of the secondary network received from other nodes (e.g., the PCF, the UDM), and/or may send the list of the secondary network to the UE.

The example shown in FIG. 23, may assist the first AMF to be aware one or more candidate networks for the secondary registration.

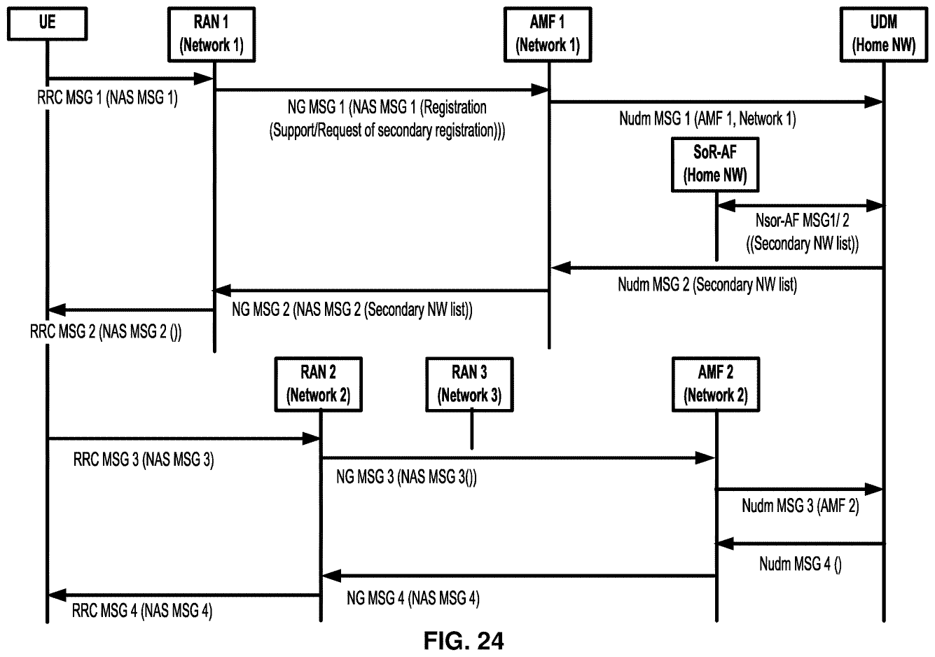

FIG. 24 may depict one example embodiment of the present disclosure. Similar to the FIGS. 22, 23, the UE may perform the primary and/or the secondary registration, based on the list of the secondary networks. In the example of FIG. 24, the AMF may receive assistant information from one or more network nodes. This may assist for the AMF to determine the list. For brevity, based on the other part of the present disclosure, redundant details will be omitted.

In an example, the first AMF may receive from the UE, the first NAS message. In response to receiving the first NAS message, the first AMF may send the first Nudm message to the UDM. For example, the UDM may be in the home network of the UE. The first Nudm message may further comprise at least one of an indication of whether the first AMF supports the feature of the secondary registration, an indication that the first AMF is the primary network, an indication that the UE requests the primary registration, and/or the like.

In an example, the UDM may receive the first Nudm message. In response to receiving the first Nudm message, the UDM may send to a roaming management node, a first Nsoraf message. For example, the roaming management node may be a SoR (steer of roaming) application function (AF). For example, the SoR AF may gather information of one or more networks, capability of the one or more networks, service agreement of the one or more networks. For example, the first Nsoraf message may be at least one of Nsoraf_SoR_Get Request message, Nsoraf_SoR_Provision Request message, and/or the like. For example, the first Nsoraf message may comprise at least one of an identifier of the UE, the identifier of the first network, the capability of the UE (e.g., support for the feature of the secondary network), the indication of the primary registration, a request for information on one or more secondary networks, and/or the like. In response to receiving the first Nsoraf message, the SoR-AF may send to the UDM, a second Nsoraf message. For example, the second Nsoraf message may be at least one of Nsoraf_SoR_Get Response message, Nsoraf_SoR_Provision Response message, and/or the like. For example, the second Nsoraf may comprise the list of the secondary networks. In response to receiving the second Nsoraf message, the UDM may send to the first AMF, the second Nudm message. The second Nudm message may further comprise information of the list of the secondary networks. In an example, the first AMF may receive from the UDM, the second Nudm message comprising the list of the secondary networks.

In an example, the AMF may send the list of the secondary network to the UE.

The example shown in FIG. 24, may assist the first AMF to be aware one or more candidate networks for the secondary registration.

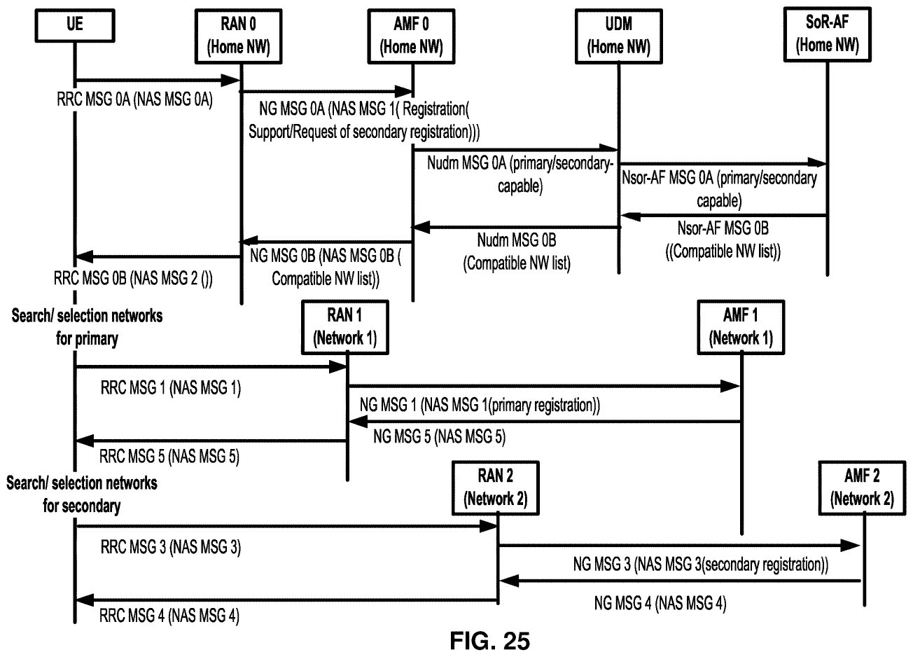

FIG. 25 may depict one example embodiment of the present disclosure. Similar to FIG. 22, the UE may perform the primary and/or the secondary registration, based on the list of the secondary networks. In the example of FIG. 25, the UE may receive information of a list of compatible networks. Based on the list of compatible networks, the UE may select one or more networks. For brevity, based on the other part of the present disclosure, redundant details will be omitted.

In an example, the UE may perform a registration to a network. The network may be a home network, and/or a visiting network. For example, when the UE is in coverage of the home network, the UE may register to the home network.

In an example, the UE may send a 0A NAS message (e.g., NAS MSG 0A) to a mobility management node of the network. For example, the UE may use a subscription of the home network, for the registration to the network. This may help for the mobility management node to verify the UE and/or relevant information. For example, the 0A NAS message may be at least one of a registration request message, a service request message, an attach request, and/or the like. For example, the 0A NAS message may indicate that the UE supports the feature of the secondary registration, that the UE requests information of one or more secondary networks, that the UE requests a service from a network supporting (or can exchange a signalling with) a secondary network, and/or the like. For example, the mobility management node may be an AMF (e.g., AMF 0), a MME, and/or the like. In an example, the UE may construct the 0A NAS message (e.g., NAS MSG 0A). The 0A NAS message may be similar to the first NAS message.

In an example, the UE may send a 0A RRC message (e.g., RRC MSG 0A) to 3GPP RAN 0. For example, the 3GPP RAN 0 may comprise at least one of a zeroth gNB, a zeroth ng-eNB, a zeroth eNB, a zeroth en-gNB, and/or the like. For example, the 0A RRC message may be at least one of a RRC setup request message, a RRC setup complete message, a RRC resume request message, a RRC resume complete message, a RRC UL transfer message, and/or the like. For example, the 0A RRC message may comprise at least one of the 0A NAS message, RRC establishment cause, and/or the like. The RRC establishment cause may indicate that the RRC connection is to establish the first access path, and/or to perform the primary registration. The zeroth 3GPP RAN may receive the 0A RRC message.

In an example, the zeroth 3GPP RAN may send a 0A NG message to the AMF. The 0A NG message may be at least one of an initial UE message, an uplink NAS transport, and/or the like. The 0A NG message may comprise similar information elements like to the first NG message. The 0A NG message may further comprise the 0A NAS message.

In an example, the AMF may receive the 0A NG message. Based on the 0A NAS message of the 0A NG message, the AMF may determine whether the UE requests the network to support the feature of the secondary registration, whether the UE indicates the support of the feature of the secondary registration, whether the UE requests information of secondary networks, whether the UE requests information of compatible networks, whether the UE indicates the support of the feature of the secondary registration, and/or whether the 0A NAS message is for the primary registration.

In an example, the AMF may send a 0A Nudm message (e.g., Nudm MSG 0A) to a data management node (e.g., UDM) of a home network. For example, the 0A Nudm message may be similar to the first Ndum message.

In an example, the UDM may send a 0A Nsoraf message to the SOR AF. For example, the 0A Nsoraf message may be similar to the first Nsoraf message. For example, the 0A Nsoraf message may indicate whether the UE supports the feature of the secondary registration, and/or whether the UE requests the feature of the secondary registration. In response to receiving the 0A Nsoraf message indicating that the UE supports the feature of the secondary registration, and/or that the UE requests the feature of the secondary registration, the SoR-AF may construct the list of compatible networks.

In an example, the list of compatible networks may indicate, for each network in the list of the compatible networks, at least one of whether the each network is allowed for primary registration, whether the each network is allowed for secondary registration, one or more networks which can be used as a secondary networks for the each network, one or more networks which can be additionally registered while the each network is registered, and/or the like. For example, the list of compatible networks may indicate that the second network can be used as the secondary network for the UE when the first network is registered for the UE. For example, the list of compatible networks may indicate that the third network cannot be used as the secondary network for the UE when the first network is registered for the UE.

In an example, the SOR AF may send a 0B Nsoraf message to the UDM. For example, the 0B Nsoraf message may comprise the list of compatible networks. In response to receiving the 0B Nsoraf message comprising the list of compatible networks and/or based on locally available information (e.g., the list of compatible networks), the UDM may send to the AMF, a 0B Nudm message (e.g., Nudm MSG 0B). For example, the 0B Nudm message may comprise the list of compatible networks. For example, the 0B Nudm message may be similar to the second Nudm message.

In an example, the AMF may receive the 0B Nudm message. Because the 0B Nudm message comprises the list of compatible networks, the AMF may send the list of compatible networks to the UE. For example, a 0B NAS message (e.g., NAS message 0B) may comprise the list of compatible networks. For example, the 0B NAS message may be similar to the second NAS message. For example, the 0B NAS message, may be a registration accept message, a UE configuration update message, UE parameter update message, a DL NAS message as specified in Annex C of 3GPP TS 23.122, and/or the like.

In an example, the AMF may send a 0B NG message (e.g., NG MSG 0B ) to the 3GPP RAN. For example, the 0B NG message may be similar to the second NG message. For example, the 0B NG message may comprise the 0B NAS message.

In an example, the 3GPP RAN may receive the 0B NG message. The 3GPP RAN may store information delivered via the 0B NG message and/or may send a 0B RRC message (e.g., RRC MSG 0B ) to the UE. For example, the 0B RRC message may comprise the 0B NAS message of the 0B NG message. For example, the 0B RRC message may be similar to the the second RRC message. The UE may receive the 0B NAS message, and may store the information of the 0B NAS message, into local memory.

In an example, the SoR information provided by the network (e.g. by the SOR AF) may comprise a set of combinations of networks (e.g. tuples consisting of (primary network identifier, secondary network identifier) that are allowed for a UE that is capable of secondary registration. The UE can use information to initiate secondary registration to a second network after successful primary registration to a first network whereby the second network is selected based on whether the SoR information contains a valid combination of the second network with the first network.

In an example, the SoR information contains one or more conditions for selecting a secondary network and/or whether or not secondary registration (in general or to a particular secondary network) is allowed, whereby the condition may be associated with a list of secondary networks, a list of compatible networks or with a combination of networks as in previous examples. Examples of such conditions may include location related conditions (e.g. only valid in certain tracking areas, geographical areas), signal quality related conditions (e.g. only allow registration to a certain (combination of) network(s) if the signal strength (of one or more networks) is above a certain threshold), QoS related conditions (e.g. allow registration to secondary network if certain QoS parameters/values (e.g. 5QI value or sustained data rate or certain maximum error rate) are required for a PDU session), temporal conditions (e.g. only valid during certain time periods), availability conditions (e.g. certain networks being available/forbidden or not being available/forbidden), emergency conditions (e.g. PDU session to be established over multiple networks if UE is involved and/or needs to set up emergency communication), and the like.

In an example, the SoR information may not be requested by the UE to the network or provided by the network (e.g. after primary registration), but may already be preconfigured (e.g. stored as part of (e)SIM profile) on the UE before primary registration.

In an example, the UE may search and/or select a network for registration. For example, the UE may find the first cell of the first network. Because the list of compatible networks indicates that the first network is allowed for the primary registration, and/or that the first network is a primary network, the UE may perform the primary registration toward the first network (for example, the example of FIG. 22 may be used).

In another example, the UE may search and/or select a network for registration. For example, the UE may find the second cell of the second network. Because the list of compatible networks or one or more combination of networks indicate that the second network is allowed for the secondary registration, e.g. when the UE is primarily registered to the first network, and/or that the second network is a secondary network, the UE may perform the secondary registration toward the second network (for example, the example of FIG. 22 may be used).

In another example, the UE may search and/or select a network for registration. For example, the UE may detect the third cell of the third network. Because the list of compatible networks or one or more combination of networks indicate that the third network is not allowed for the secondary registration, e.g. when the UE is primarily registered to the first network, the UE may not perform the secondary registration toward the third network.

The example of FIG. 25 may assist the first network and/or the UE. For example, if the service agreement between the home network and the second network is not known, the first network may not have detailed information of one or more networks allowed for the secondary networks. For example, before performing registration to the first network, the UE may not know which network can be used for the primary registration. The example of FIG. 25 may help for the first network and/or the UE.

In the example of FIG. 25, the actions of the RAN 0 may be performed by the first RAN and/or the actions of the AMF 0 may be performed by the first AMF. In other words, the information (e.g., the list of compatible networks) can be delivered to the UE via the visiting networks. In the example of FIGS. 22, 23 and 24, the list of compatible networks may be alternatively and/or additionally used for the list of secondary networks.

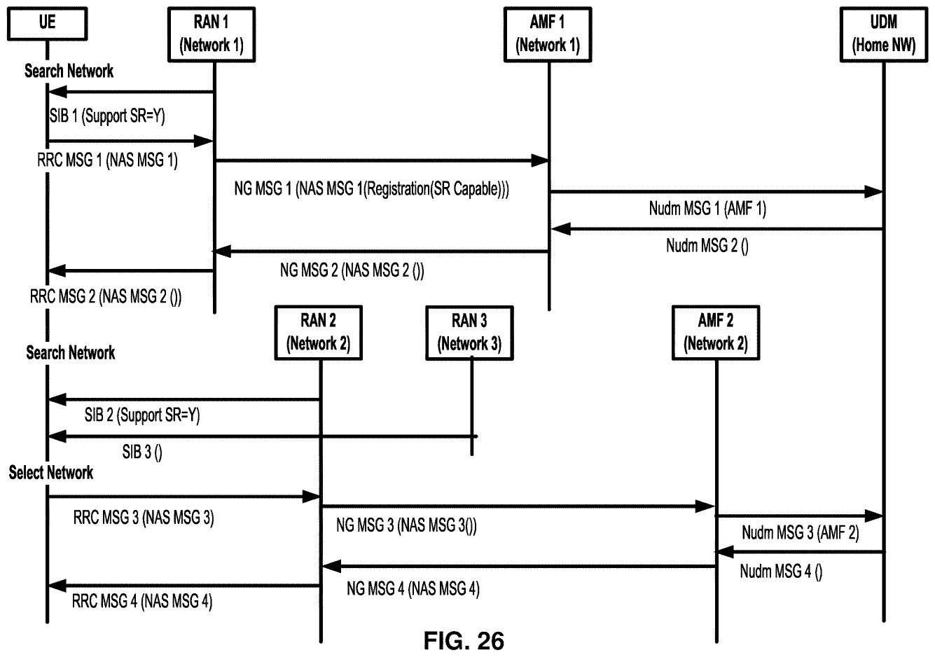

FIG. 26 may depict one example embodiment of the present disclosure. The UE may receive from a cell, information of whether a network supports the feature of secondary registration. This may assist the UE to determine whether to perform a primary registration and/or a secondary registration. For brevity, based on the other part of the present disclosure, redundant details will be omitted.

In an example, the UE may search/detect one or more cells available at a location of the UE. For one or more detected cells, the UE may receive system information (e.g., SIB, system information block). For example, the one or more cells may comprise at least one of the first cell, the second cell, the third cell. For example, the first cell may be a cell of the first network, the second cell may be a cell of the second network, and/or the third cell may be a cell of the third network. For example, the first cell may broadcast a first SIB, and the first SIB may indicate that the first network supports the feature of the secondary network. For example, the second cell may broadcast a second SIB, and the second SIB may indicate that the second network supports the feature of the secondary network. For example, the third cell may broadcast a third SIB, and the third SIB may indicate that the third network does not support the feature of the secondary network.

In an example, the UE may receive the first SIB from the first cell. Because the first SIB indicates support of the feature of the secondary registration, the UE may determine to perform a primary registration to the first network. For example, the UE may send the first NAS message, the first AMF may receive the first NAS message, the first AMF may send the first Nudm message, the first AMF may receive the second Nudm message, the first AMF may send the second NAS message to the UE, and/or the UE may receive the second NAS message, as similar to the FIG. 22.

In an example, reverting back to FIG. 26, in response to receiving the second NAS message, the UE may determine to perform the secondary registration. For example, the UE may receive the second SIB from the second cell and/or the UE may receive the third SIB from the third cell. Because the second SIB indicates the support of the feature of the secondary registration, the UE may determine to perform the secondary registration to the second network. Because the third SIB does not indicate the support of the feature of the secondary registration, the UE may determine not to perform the secondary registration to the third network and/or may determine not to select the third network. For example, the UE may send the third NAS message, the second AMF may receive the third NAS message, the second AMF may send the third Nudm message, the second AMF may receive the fourth Nudm message, the second AMF may send the fourth NAS message to the UE, and/or the UE may receive the fourth NAS message, as similar to FIG. 22.

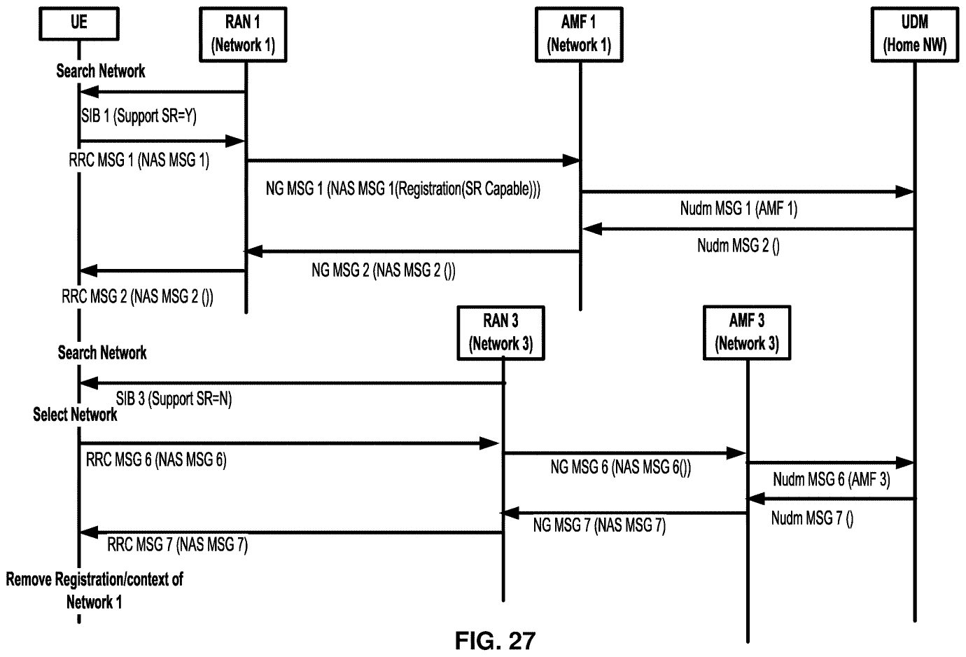

FIG. 27 may depict one example embodiment of the present disclosure. Similar to FIG. 26, the UE may receive from a cell whether a network supports the feature of secondary registration. Reverting to FIG. 27, this may assist the UE to determine how to manage registration status. For brevity, based on the other part of the present disclosure, redundant details will be omitted.

In an example, after registration to the first network, the UE may receive the third SIB from the third cell. In an example, the UE may not detect the second cell and/or may not detect one or more cells (of other networks than the first network) indicating support of the feature of the secondary registration. Alternatively, after registration to the first network, the UE may move into area where a cell of the first network is not available.

In an example, the UE may determine to perform registration procedures via the third cell of the third network. The UE may send a sixth RRC message (e.g., RRC MSG 6) to the third cell (or a third RAN) of the third network. For example, the sixth RRC message may comprise a sixth NAS message (e.g., NAS MSG 6). For example, the sixth NAS message may be similar to the third NAS message. For example, the sixth NAS message may or may not indicate that the UE requests a secondary registration, that the UE supports the feature of the secondary registration, and/or the like.

In response to receiving the sixth NAS message, a third AMF (of the third network, e.g., AMF 3) may send a sixth Nudm message (e.g., Nudm MSG 6) and/or may receive a 7^{th}Nudm message (e.g., Nudm MSG 7) from the UDM. The 7^{th} Nudm message may or may not be similar to the fourth Nudm message. For example, the 7^{th} Nudm message may indicate that the third network is not allowed for the secondary registration for the UE.

In an example, the third network (e.g., AMF 3) may not support the feature of the secondary registration, may not be allowed for the secondary registration. The AMF 3 may send a 7^{th} NAS message to the UE. For example, the 7^{th} NAS message may indicate that the UE is registered to the third network, may not indicate that the third network supports the secondary registration, and/or may not indicate that the secondary registration of the UE to the third network is accepted.

In an example, the UE may receive the 7^{th} NAS message. Because the 7^{th} NAS message indicates acceptance of registration, because the third network does not support the feature of the secondary registration, and/or because the third SIB does not indicate support for the feature of the secondary registration, the UE may determine to change registration status associated with the first network. For example, the UE may determine that the primary registration to the first network ends (deleted, released, deregistered), that the UE is not registered to the first network, and/or that the secondary registration is not used/suspended, and/or the like. For example, the UE may delete/discard information (e.g., an identifier allocated by the first network, a security context associated with the first network, a configuration parameter (e.g., registration area, PDU session status) associated with the first network, and/or the like) associated with the first network.

The example of FIG. 27 may assist the UE in managing connection which is not relevant.

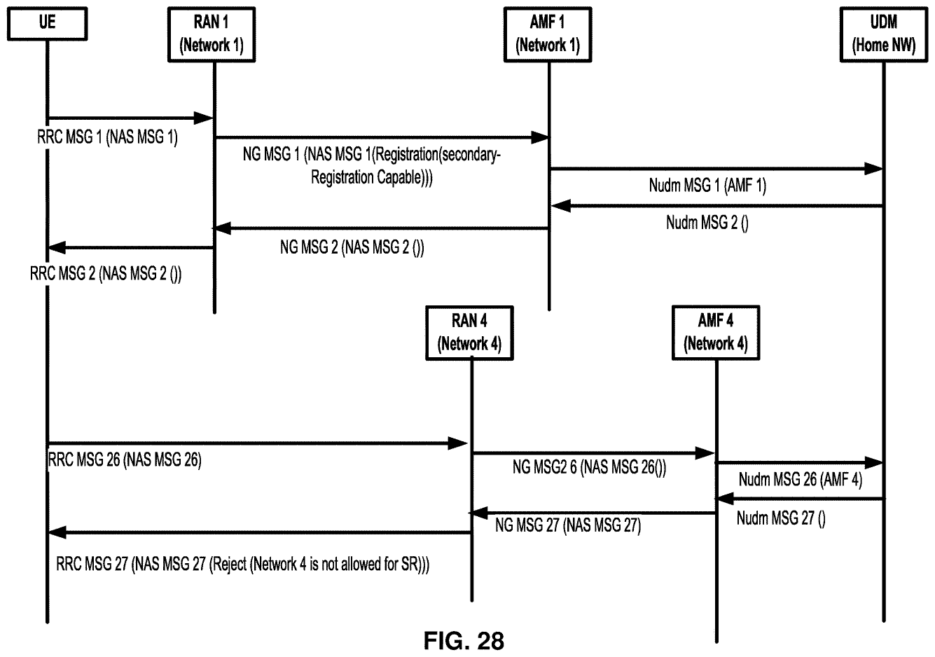

FIG. 28 may depict one example embodiment of the present disclosure. Similar to FIG. 22, the UE may perform the primary and/or may attempt the secondary registration. In the example of FIG. 28, the UE may attempt the secondary registration toward a cell of a network from which the UE may not get a service. For brevity, based on the other part of the present disclosure, redundant details will be omitted.

In an example, after performing registration to the first network (as shown in the example of FIG. 22), the UE may perform a registration procedure to a fourth network (e.g., network 4). For example, the UE may detect a fourth cell of the fourth network, when the UE cannot detect a cell of the first network and/or when the UE cannot detect a cell of a network in the list of the secondary network.

In an example, the UE may send a 26^{th} NAS message (e.g., NAS MSG 26) to a fourth AMF of the fourth network. For example, the 26^{th} NAS message may be similar to the sixth NAS message.

In response to receiving the 26^{th} NAS message, the fourth AMF may send a 26^{th}Nudm message (e.g., Nudm MSG 26) and/or may receive a 27^{th} Nudm message (e.g., Nudm MSG 27) from the UDM. The 27^{th} Nudm message may or may not be similar to the 7^{th}Nudm message. For example, the 27^{th} Nudm message may indicate that the fourth network is not allowed for the secondary registration for the UE.

In an example, the fourth network (e.g., AMF 4) may not support the feature of the secondary registration, may not be allowed for the secondary registration. The AMF 4 may send a 27^{th} NAS message to the UE. For example, the 27^{th} NAS message may indicate that the registration request of the UE to the fourth network is rejected, may indicate that the secondary registration of the UE to the fourth network is rejected, may indicate that the secondary registration is not supported by the fourth network, and/or the like.

In an example, the UE may receive the 27^{th} NAS message. Because the 27^{th} NAS message indicates at least one of rejection of registration, not supporting the feature of the secondary registration, and/or not allowing the secondary registration, the UE may determine that secondary registration to the fourth network is not successful, may add the fourth network in the list of networks rejected for the secondary registration. For example, for a network in the list of networks rejected for the secondary registration, the UE may not select the network for the secondary registration, may not use the network for the secondary registration, may not send a registration request requesting the secondary registration to the network, may use the network for other registration than the secondary registration, and/or the like. For example, because the UE requests the secondary registration and/or because the UE receives indication of rejection of registration, the UE may determine that the network does not allow the secondary registration. Based on the determination, the UE may not trigger another secondary registration procedure to the network in the list of networks rejected for the secondary registration, and/or the UE may trigger a registration procedure (e.g., not for secondary registration) for the network in the list of networks rejected for the secondary registration. This may help the UE reduce unnecessary requests to the fourth network.

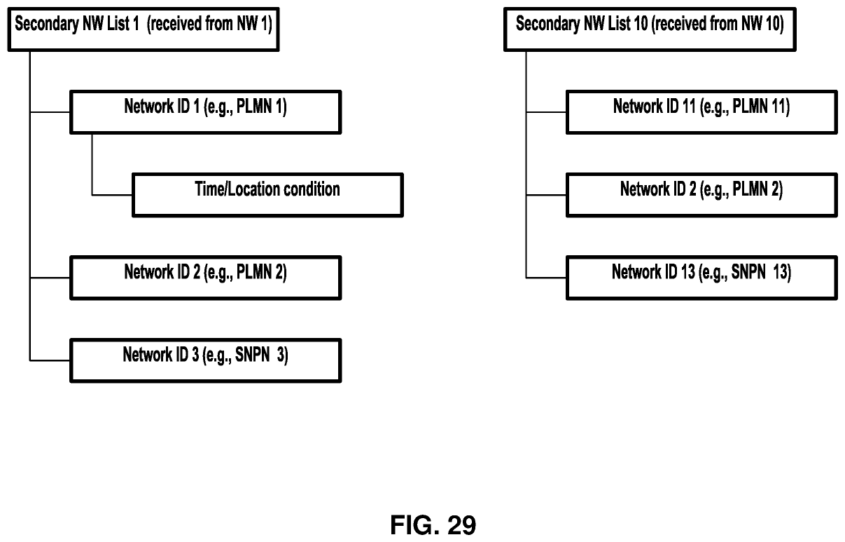

FIG. 29 may depict one example embodiment of the present disclosure. For example, a network (e.g., in previous figures) may send the list of secondary networks and/or the list of compatible networks, to the UE. For brevity, based on the other part of the present disclosure, redundant details will be omitted.

In an example, the UE may receive one or more list of secondary networks from one or more networks. For example, the one or more list of secondary networks may comprise a first list of secondary networks and/or a tenth list of secondary networks. For example, the UE may receive the first list of secondary networks from the first network and/or the UE may receive the tenth list of the secondary networks from a tenth network.

In an example, each of the one or more list of secondary networks may comprise one or more identifiers of the one or more secondary networks and/or (for each secondary network) one or more conditions where the UE is allowed to use the each secondary network. For example, the first list of secondary networks may comprise a first one or more identifiers of a first one or more secondary networks. For example, the first one or more identifiers may comprise a first network ID (e.g., network ID 1, PLMN 1), a second network ID (e.g., network ID 2, PLMN 2), and/or a third network ID (e.g., network ID 3, SNPN 3), and/or the like. For example, the first list of secondary networks may comprise one or more conditions for the first one or more secondary networks. For example, the one or more conditions may comprise a first condition for the first network ID, a second condition for the second network ID, and/or a third condition for the third network ID. For example, the first condition may comprise an information of a first time (e.g., PM 2:00, for 30 minutes, and/or the like) and/or a first location (e.g., city A, TA B).

For example, for each network in the list of secondary network, the UE may determine whether the each network is allowed for secondary registration. For example, based on the first condition, if the time is PM 2:00, and/or if the UE is in the city A, the UE may determine that the UE is allowed to perform the secondary registration to the network (e.g., the first network ID). For example, based on the first condition, if the time is not PM 2:00, and/or based on that the UE is not in the city A, the UE may determine that the UE is not allowed to perform the secondary registration to the network (e.g., the first network ID) and/or may not send a request for the secondary registration.

For example, if the UE is (primarily) registered to the first network, the UE may determine to use the first list of secondary networks. For example, if the UE is (primarily) registered to the first network, the UE may determine not to use the tenth list of secondary networks.

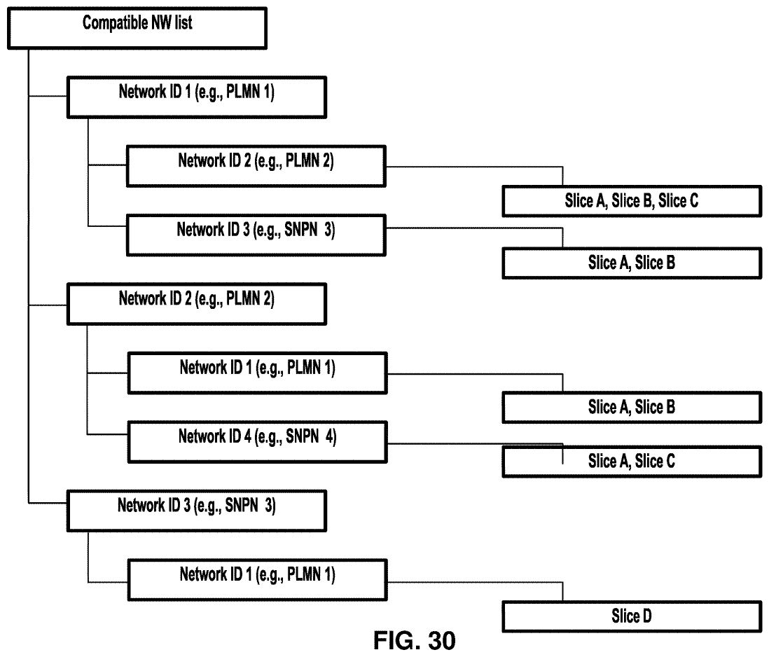

FIG. 30 may depict one example embodiment of the present disclosure. For brevity, based on the other part of the present disclosure, redundant details will be omitted.

In an example, the list of compatible networks may comprise information indicating combination of networks allowed for primary/secondary registration and/or combination of network allowed for multiple (coordinated, dual, double, and/or the like) registration. For example, the list of compatible networks may indicate that:
For a first network (e.g., network ID 1, PLMN 1), a second network (e.g., network ID 2, PLMN 2) and/or a third network (e.g., network ID 3, SNPN 3) can be used as a secondary network. I.e., when the UE is registered to the first network, the UE is allowed to perform a secondary registration to the second network and/or the third network.
For the second network (e.g., network ID 2, PLMN 2), the first network and/or a fourth network (e.g., network ID 4, SNPN 4) can be used as a secondary network. I.e., when the UE is registered to the second network, the UE is allowed to perform a secondary registration to the first network and/or the fourth network.

In an example, the UE may receive the list of compatible network from a home network and/or via a visiting network. For example, the UE may receive the list of compatible networks from a UDM, via an AMF (of the home network and/or the visiting network). The list of compatible networks may indicate which one or more target networks can be used for secondary registration when the UE is registered for a certain network. In this case, if the certain network may not send information of candidate networks for the secondary network, the UE may select/determine a network in the list of compatible networks and performs the second registration with the network.

In an example, the list of compatible networks may further comprise information of one or more conditions (e.g., similar to the example shown in FIG. 29). In the example of FIG. 30, the one or more conditions may further comprise information of one or more network slices. For example, the one or more network slices may be allowed for a combination of networks and/or when the UE is registered for the primary/secondary network. For example, the UE may subscribe to one or more network slices via the home network. Because the home network manages which network services are allowed to the UE, the home network (e.g., the UDM, the SoR-AF, and/or the like) may be able to determine which network slices can be used when the UE registers to one or more networks for the secondary registration.

In an example, for the combination of the first network and the second network, the list of compatible networks may indicate that slice A, slice B, and/or slice C are allowed. For example, for the combination of the first network and the third network, the list of compatible networks may indicate that slice A, and/or slice B are allowed. For example, based on the list of compatible networks, the UE may determine to which networks the UE performs the primary registration and/or the secondary registration. For example, if the UE wants to use the network slice A, the UE may determine to perform the primary registration to the first network and/or the UE may determine to perform the secondary registration to the second network. For example, if the UE wants to use the network slice E, and if there is no combination of networks for the network slice E in the list of compatible networks, the UE may determine not to perform the secondary registration for the network slice E. In another example, the UE may be primarily registered to the first network and/or may be secondary registered to the second network. In this case, because the list of compatible networks indicates that the network slice B is allowed, the UE may request registration (or PDU session) of the network slice B to the first network and/or to the second network. In this case, because the list of compatible networks does not indicate that the network slice D is allowed, the UE may not request registration (or PDU session) of the network slice D to the first network and/or to the second network.

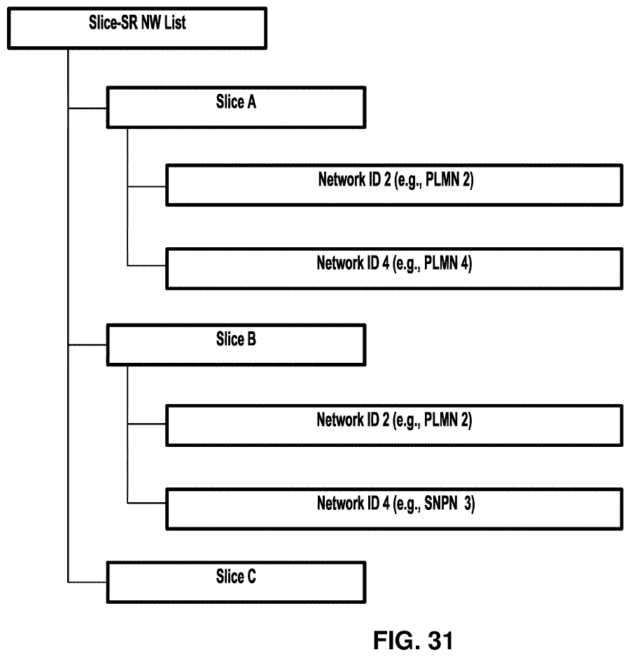

FIG. 31 may depict one example embodiment of the present disclosure. Similar to the example of FIG. 29 and/or FIG. 30, the list of secondary networks and/or the list of compatible networks may indicate one or more pairs of networks allowed for primary/secondary registration. In the example of FIG. 31, the list of secondary networks may indicate an associated network slice. For brevity, based on the other part of the present disclosure, redundant details will be omitted.

In an example, the list of secondary networks may indicate one or more network slices. For example, the one or more network slices may be one or more configured network slices and/or one or home (subscripted) network slices. For each of the one or more network slices, the list of secondary network(s) may indicate one or more networks allowed for the secondary registration. For example, after primary registration to the first network, the UE may receive the list of secondary networks. For example, the list of secondary networks may indicate that the second network (e.g., network ID 2) is allowed for the secondary registration and/or for the slice A. For example, the list of secondary networks may indicate that the second network (e.g., network ID 2) is allowed for the secondary registration and/or for the slice B. For example, after registration to the first network, if the UE needs to register for the slice A, because the list of secondary networks indicates that the slice A is allowed from the secondary network (e.g. the second network), the UE may perform secondary registration to the second network. For example, after primary registration to the first network and/or after the secondary registration to the second network, because the list of secondary networks indicates that the slice A is allowed from the secondary network (e.g. the second network), the UE may send a request to the second network, for the slice A.

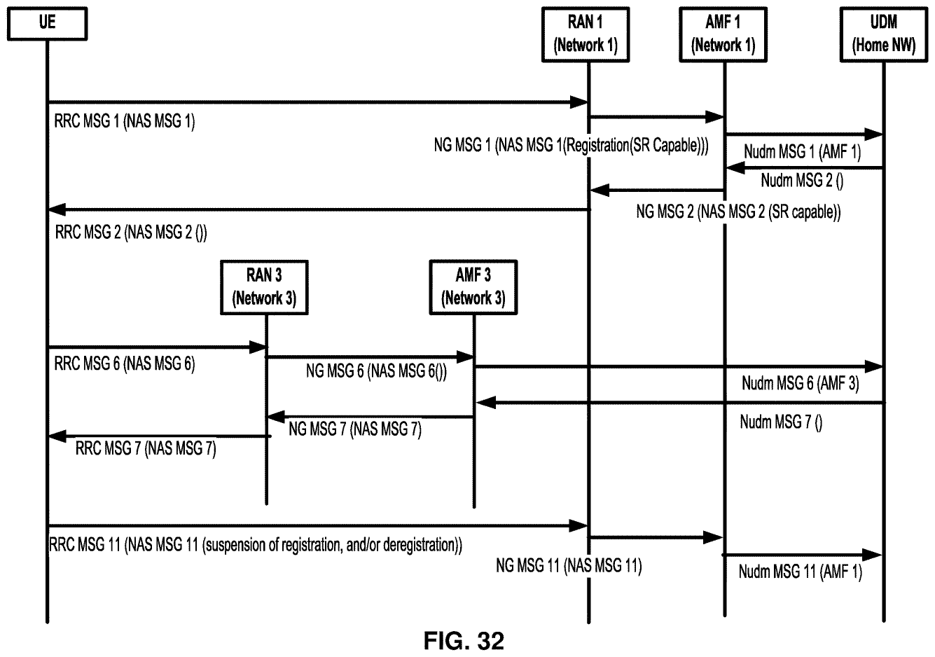

FIG. 32 may depict one example embodiment of the present disclosure. Similar to FIG. 27, the UE may perform the primary registration to the first network. In the example of FIG. 32, the UE may perform a registration to a third network which does not support the secondary registration and/or may inform the first network. For brevity, based on the other part of the present disclosure, redundant details will be omitted.

In an example, the UE may send the first NAS message and/or may receive the second NAS message from the first network. For example, the second NAS message may indicate that the first AMF and/or the first network supports the feature of secondary registration.

In an example, after the primary registration to the first network, the UE may determine to do additional registration. For example, the UE may search for other available networks and/or the UE may not find a network supporting the secondary registration. In an example, the UE may detect a third cell of a third network not supporting the secondary registration. For example, the UE may send the sixth NAS message to the third AMF and/or may receive the 7^{th} (seventh) NAS message from the third AMF. For example, the 7^{th} NAS message may indicate that the third network (or the third AMF) does not support the feature of the secondary registration.

In an example, because the UE is primarily registered to the first network and/or because the UE registers to the third network not supporting the feature of the secondary registration, the UE may send to the first AMF, a 11^{th} NAS message. For example, the 11^{th} NAS message may be at least one of a registration request, a service request, and/or the like. For example, the 11^{th} NAS message may indicate at least one of a suspension of the primary registration, a deregistration of the primary registration, request of deregistration, unavailability of the secondary network, registration to a network not supporting the secondary network, and/or the like.

In an example, the first AMF may receive the 11^{th} NAS message. Because the 11^{th} NAS message indicates at least one of the suspension of the primary registration, the deregistration of the primary registration, the request of deregistration, the unavailability of the secondary network, the registration to a network not supporting the secondary network, and/or the like, the first AMF may perform at least one of deregistration of the UE, suspension of service to the UE, notification to one or more SMFs handling one or more PDU sessions for the UE, suspension of functionality to support the secondary registration, suspension of functionality associated with the primary registration, deregistration of the AMF from the UDM, de-allocation of resource for the UE in the first network, not sending any signalling to the UE until the UE performs the second registration, and/or the like.

The example of FIG. 32 may reduce unnecessary activity in the first network, to manage the context of the UE, when the UE is not able to the feature of the secondary registration.

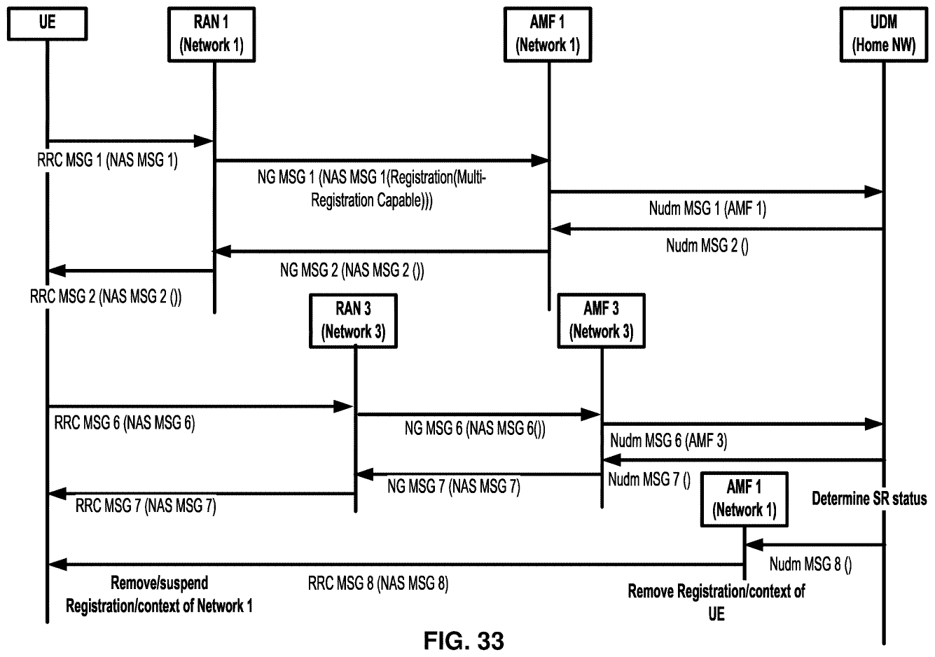

FIG. 33 may depict one example embodiment of the present disclosure. Similar to FIG. 32, the UE may perform a registration to a third network which does not support the secondary registration. In the example of FIG. 33, the first AMF is notified of secondary registration status. For brevity, based on the other part of the present disclosure, redundant details will be omitted.

In an example, after the first registration to the first network, the UE may perform registration to the third network. For example, in response to receiving the 6^{th} NAS message, the third AMF may register the third AMF to the UDM, by sending the 6^{th} Nudm message. For example, the 6^{th} Nudm message may not indicate that the third AMF and/or the third network supports the feature of the secondary registration.

In an example, the UDM may receive the sixth Nudm message. Because the sixth Nudm message does not indicate the support of the feature of the secondary registration, the request for the secondary registration, and/or the like, the UDM may determine that the third network does not support the feature of the secondary registration. The UDM may determine whether there is a network/AMF for the UE for the primary registration. For example, because the first AMF sends to the UDM, the first Nudm message, and/or because the UDM has the stored information of the first AMF, the UDM determine that there is a registered AMF/network for the primary registration for the UE. Because the first AMF/network is registered for the primary registration and/or because the third AMF/network does not support the feature of the secondary registration, the UDM may determine to send a notification to the first AMF/network. For example, the notification may indicate at least one of that the UE is registered to a network not supporting the secondary registration, that the first network/AMF needs to discard/delete/de-register the UE from the first AMF/network, that the first network/AMF suspends the primary registration of the UE, and/or the like.

In an example, in response to the received notification, the first AMF/network may determine to deregister the UE and/or may send a 8^{th} NAS message to the UE. For example, the 8^{th} NAS message may indicate at least one of deregistration of the UE from the first network, suspension of the registration/activity of the UE in the first network, and/or the like.

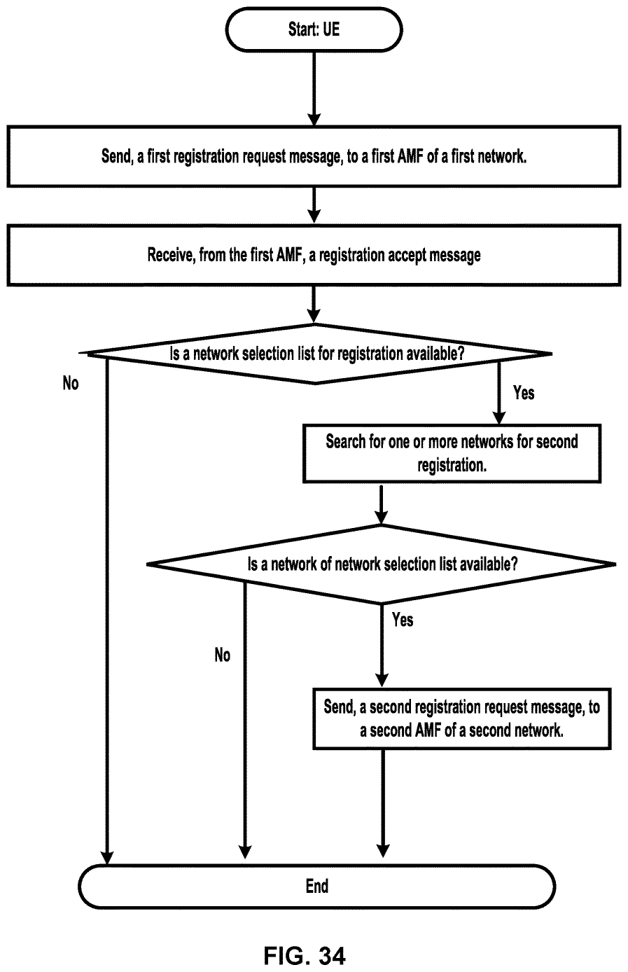

FIG. 34 may depict one example embodiment of the present disclosure. Similar to FIG. 22, the UE may use the list of secondary networks for selection of the network. For brevity, based on the other part of the present disclosure, redundant details will be omitted.

In an example, the UE may send a first message (e.g., registration request message) to a first node (e.g., an AMF) of the first network. For example, the first message may indicate support for the feature of the secondary registration, request of a primary registration, request of a support of the feature of the secondary registration, and/or the like.

In an example, the UE may receive from the first node, a second message (e.g., registration accept message, UE configuration update, and/or the like). For example, the second message may indicate at least one of support of the feature of the secondary registration, successful registration, acceptance of the primary registration, allowance of using the secondary network, allowance of performing the secondary registration, a list of secondary networks (e.g., network selection list for secondary (multiple, additional, dual, and/or the like) registration.

In an example, the UE may determine to perform the secondary registration. In an example, the UE may determine whether the network selection list is available or not. For example, if the network selection list is available, the UE may determine to perform the secondary registration and/or may start searching one or more networks in the network selection list. For example, the network selection list may be the list of secondary networks.

In an example, the UE may determine whether the one or more networks in the network selection list is detected/available. If the one or more networks are available and/or if the UE detects a cell of the one or more networks, the UE may select a second network of the one or more networks and/or may perform a secondary registration. For example, the UE may send a third message (e.g., a registration request, a service request) to the second network (or the second AMF). For example, the third message may indicate at least one of a request of the secondary registration.

In an example, a UE may send to a first mobility management node of a first network, a first message indicating support for a secondary registration to a secondary network associated with the first network. For example, the first mobility management node may be at least one of an AMF, a MME, a SMF, a UDM, a SoR-AF, and/or the like. For example, the first network may be at least one of a PLMN, a SNPN, a PNI-NPN, and/or the like. For example, the first network may be at least one of a home network, a first visiting network. For example, the first message may be at least one of a registration request message, an attach request message, a service request, and/or the like. For example, the first message may comprise at least one of an identifier of the UE, one or more identifiers of one or more requested network slices, an indication that the UE requests network's support of the secondary registration, an indication that the UE requests a primary registration, an indication that the UE requests information of one or more networks supporting (or allowed for) the secondary registration, and/or the like. For example, the UE may send the first message, via a first access type.

In an example, the support for the secondary registration may be at least one of the support for the feature of the secondary (multiple) registration, the support for the multiple (additional, dual, subsequent, concurrent, simultaneous, and/or the like) registrations via multiple networks with a subscription. For example, the support for the secondary registration may indicate at least one of that the UE is capable of performing the secondary registration. For example, the UE may indicate that the UE supports the secondary registration to the secondary network. For example, the UE may perform the secondary registration to the secondary network. For example, the secondary network may be associated with the first network. For example, the secondary network may be able to exchange signalling with the first network. For example, the secondary network may allow the UE to register to the secondary network, while the UE is registered to the first (e.g., primary) network. For example, the UE may register to the secondary network using the first access type (e.g., 3GPP RAN, 3GPP RAT, NG-RAN, NR), while the UE is registered to the first network via the first access type.

In an example, the UE may receive from the first mobility management node, a second message comprising information of one or more candidate networks for the secondary registration. For example, the second message may be at least one of UE configuration update message, a registration accept message, a service accept message, a DL NAS transfer message, and/or the like. For example, the information of the one or more candidate networks may comprise one or more identifiers of the one or more networks for the primary network. For example, the one or more networks may be one or more secondary networks. For example, the one or more networks may be one or more networks that the UE is allowed to perform the secondary registration. For example, the one or more candidate networks may comprise an allowed network. For example, the allowed network may be a second network. For example, the secondary registration may be at least one of that the UE is registered to the allowed network for an access type while the UE is registered to the first network for the access type, that the UE registers (is registered to) more than one networks with the access type, that more than one networks for the access type serve the UE, that more than one mobility management nodes for the access type serve the UE, or that the UE is registered to more than one mobility management nodess for the access type (e.g., 3GPP access). For example, the second message may indicate whether the first network supports the feature of the secondary registration, and/or whether the UE is allowed to perform the secondary registration. For example, the second message may indicate one or more network slices supported by the secondary networks and/or allowed for the secondary registration, e.g. the second message may contain a policy container containing a set of URSP rules that may indicate for a set of applications which slice to use for PDU session establishment via the primary and/or secondary registration. For example, the one or more network slices may be supported by the first network and/or the secondary networks. For example, each of the secondary networks may be at least one of a PLMN, a SNPN, a PNI-NPN, and/or the like. The URSP rules may indicate that the PDU session over the secondary network needs to use the same PDU session ID as the PDU session over the primary network. The URSP rules may contain conditions that indicate minimal signal strength or whether certain networks (e.g. indicated by PLMN ID) are (un)available to the UE and/or which SUPI the URSP rule applies to, and only when the conditions are met the UE may use the respective URSP rule. Note that the policy updates (e.g. containing updated URSP rules using UCU procedure) may be performed before requesting/establishing a PDU session or a set of associated PDU sessions over both primary and secondary network, hence after receiving the second message, the UE may (re-)perform primary registration to a first network and/or (re-)establish a PDU session over a first network. This implies there may be a big time gap between the second message and the third message described below.

In an example, the UE may search, measure and/or detect one or more cells. The one or more cells may be available at location of the UE. For example, the one or more cells may comprise one or more second cells of the second network and/or one or more third cells of a third network. For example, the one or more candidate networks for the secondary registration may comprise the second network, and/or may not comprise the third network. Based on the information of the one or more candidate networks (e.g., because the one or more candidate networks comprise the second network), and because the UE detects a second cell of the second network, the UE may select the second cell and/or the second network. In an example, the UE may receive from the one or more cells, one or more SIBs. For example, each of the one or more SIBs may indicate whether a network associated with the cell supports the feature of the secondary registration or not.

In an example, the UE may send to a second mobility management node of the second network (e.g., the allowed network), a third message requesting the secondary registration. For example, the third message may be at least one of a registration request, a service request, and/or the like. For example, the third message may indicate at least one of that the UE requests the secondary registration and/or that the UE supports the secondary registration. For example, the UE may send the third message, via the first access type (e.g., 3GPP access type).

In an example, the UE may be primarily registered to the first network and/or may be secondary registered to the second network. The UE may request establishment of a multiple access PDU session using resources of the first network and/or the second network.

In an example, alternatively and additionally, the first network may be the second network. For example, the information of the one or more candidate networks may comprise information indicating one or more RAT (e.g., NR, LTE, E-UTRA, 6G radio, and/or the like) types, one or more RAN (E-UTRAN, NG-RAN, 6G-RAN, a satellite RAN, a terrestrial RAN, and/or the like) types, and/or one or more core network (EPC, 5GC, 6GC, and/or the like). For the secondary registration and/or for the selection of secondary network (e.g., access leg, RAT, RAN), the UE may use the information of the one or more candidate networks. For example, if the information of the one or more candidate networks indicates at least one of a first RAT type (e.g., NR), a first RAN type (e.g., a satellite RAN), and/or the like, the UE may select a cell (or a network) of the first RAT type, the first RAN type, and/or the like. Based on selecting the cell (or the network), the UE may send the third message. For example, the UE may access the second network using a first subscription. For example, the UE may access the first network with the first subscription. For example, the first subscription may be associated (used, allocated) with the home network of the UE.

In an example, a first mobility management node of a network may receive from a wireless device, a registration request message indicating support for a secondary registration with a secondary network associated with the network. The first mobility management node may receive from a second control plane node, a configuration information indicating an allowed network for the secondary registration. The first mobility management node may send to the wireless device, a registration accept message comprising information of the allowed network.

In an example, a mobility management node of a primary network may receive from a wireless device, a first non-access stratum (NAS) message indicating that the wireless device support secondary registration. The mobility management node may receive from a data (policy) management node, an information of one or more secondary networks allowed for the secondary registration and/or an indication whether use of the secondary networks (or secondary registration) is allowed. The mobility management node may send to the wireless device, a second NAS message comprising the information of the one or more secondary networks.

In an example, a wireless device may receive from a mobility management node (of a home network), a message indicating one or more first networks and one or more second networks for (associated with) at least one first network of the one or more first networks. The wireless device may be allowed for registration to at least one second network of the one or more second networks, while registered to at least one first network. The wireless device may send to the at least one second network, a registration request message.

In an example, a wireless device (e.g., UE) may receive from a base station (e.g., a gNB, a cell, an eNB) of a network, a first RRC message (e.g., SIB) indicating that the network supports a secondary registration. The wireless device may send to the base station, a second RRC message. For example, the second RRC message may comprise an indication that the UE requests a connection to a secondary network. For example, the second RRC message may comprise a registration request message requesting secondary registration.

1. A method comprising:
sending a first message to a first mobility management node of a network, wherein the first message indicates support for a secondary registration to a secondary network associated with the network;
receiving a second message from the first mobility management node, wherein the second message comprises information of an allowed network for the secondary registration; and
sending a third message to a second mobility management node of the allowed network, wherein the third message requests the secondary registration.

2. The method of claim 1, further comprising selecting the allowed network for the secondary registration.

3. A method comprising:
receiving a first message from a first mobility management node of a network, wherein the first message comprises information of at least one secondary networks allowed for secondary registration with the network; and
sending
a second message to a second mobility management node of an allowed network of the at least one secondary networks, wherein the second message comprises requesting a secondary registration.

4. The method of claim 1, wherein the first mobility management node is at least one of an access and mobility management function or a mobility management entity.

5. The method of claim 1, wherein the first message is at least one of a UE configuration update message and a registration accept message.

6. The method of claim 1, wherein the second message is at least one of a registration request and a service request message.

7. The method of claim 1, further comprising sending a message to the first mobility management node of the network, wherein the message indicates support for secondary registration.

8. The method of claim 1, wherein secondary registration includes at least one of:
the wireless device is registered to the allowed network for an access type while the wireless device is registered to the network for the access type, the wireless device registers more than one networks with the access type, more than one networks for the access type serve the wireless device, more than one mobility management nodes for the access type serve the wireless device, or the wireless device is registered to more than mobility managements for the access type.

9. The method of claim 1, further comprising selecting the allowed network of the at least one secondary networks.

10. The method of claim 1, further comprising measuring at least one cells of at least one networks.

11. The method of claim 9, wherein the wireless device selects the target network based on measuring a cell of the target network.

12. The method of claim 1, further comprising receiving by the wireless device, a system information block from the target network.

13. The method of claim 12, wherein the system information block indicates whether the target network supports the secondary registration.

14. The method of claim 1, wherein the second message further comprises an indication indicating whether the primary network supports secondary registration.

15. The method of claim 1, wherein the second message is sent based on that the primary network supports secondary registration.

16. The method of claim 1, wherein the second message further comprises an indication of at least one network slices supported by a network of the at least one secondary networks.

17. The method of claim 16, wherein a network slice of the at least one network slices is secondary network slice supported by the primary network and the secondary network.

18. The method of claim 1, wherein each of the at least one secondary networks is at least one of a PLMN, a SNPN, a PNI-NPN.

19. The method of claim 18, wherein the second message indicates an identifier of each network of the at least one networks.

20. The method of claim 1, further comprising establishing by the wireless device, a protocol data unit session using a resource of the primary network and a resource of the target network.

21. The method of claim 1, further comprising:
establishing a first protocol data unit session using a resource of the primary network; and
establishing a second protocol data unit session using a resource of the target network.

22. The method of claim 21, further comprising receiving a policy container containing a set of URRSP rules that indicate at least one of:
for a set of applications which slice to use for protocol data unit session establishment,
the protocol data unit session over the target network needs to use the same protocol data unit session ID as the protocol data unit session over the primary network, and
minimal signal strength or whether certain networks are unavailable or available to the UE

23. The method of claim 20, wherein the wireless device establishes the protocol data unit session, after receiving a registration accept from the target network.

24. The method of claim 1, wherein the wireless device accesses the target network via a 3GPP access type.

25. The method of claim 1, wherein the wireless device accesses the primary network via a 3GPP access type.

26. The method of claim 24, wherein a wireless device accesses the primary network, via the 3GPP access type and the target network via the 3GPP access type.

27. The method of claim 1, wherein a wireless device uses a first subscription for access to the primary network.

28. The method of claim 27, wherein a wireless device uses the first subscription for access to the target network.

29. The method of claim 27, wherein the first subscription is associated with a home network of a wireless device.

30. The method of claim 1, wherein a wireless device uses a first access type for accessing the primary network.

31. The method of claim 30, wherein the wireless device uses the first access type for accessing the target network.

32. A method comprising:
receiving a registration request message,
wherein the registration request message indicates support for a secondary registration with a secondary network,
wherein the secondary network is associated with the network;
receiving, a configuration information, wherein the configuration information indicates an allowed network for the secondary registration; and
sending a registration accept message, wherein the registration accept message comprises information of the allowed network.

33. A method comprising:
receiving a first non-access stratum message, wherein the non-access stratum message indicates that the wireless device support secondary registration;
receiving an information of at least one secondary networks allowed for the secondary registration; and
sending a second non-access stratum message, wherein the non-access stratum message comprises the information of the at least one secondary networks.

34. A method comprising:
receiving an information from a data management node, wherein the information is of at least one secondary networks allowed for a secondary registration; and
sending a second non-access stratum message, wherein the second non-access stratum message comprises the information of the at least one secondary networks.

35. A method comprising sending an indication to a steering of roaming application function, wherein the indication indicates a wireless device supports a secondary registration.

36. A method comprising:
receiving, by a wireless device from a mobility management node the message indicating:
at least one first networks; and
at least one second networks for at least one first network of the at least one first networks, wherein the wireless device is allowed for registration to at least one second network of the at least one second networks with the at least one first network; and
sending a registration request message to the at least one second network.

37. A method comprising:
receiving a message, wherein the message indicates that the network does not support a secondary registration; and
deregistering from a primary registration.

38. A method comprising:
receiving a RRC message, wherein the RRC message indicates that the network supports a secondary registration; and
sending a registration request message to the base station, wherein the request message request secondary registration.

39. A method comprising receiving a message, wherein the message indicates that a secondary registration is rejected.

40. A method comprising:
receiving a message, wherein the message indicates that the network does not support a secondary (multiple) registration; and
sending a deregistration message to a primary network.

41. A method comprising:
receiving a registration request for a wireless device from a second mobility management function, wherein the registration request is associated with a plurality of access paths of an access type; and
sending a message from a second mobility management function, wherein the message indicates the first mobility management function is deregistered.

42. A method comprising:
sending, a first message, wherein the first message indicates support for a secondary registration with at least one secondary network associated with the primary network;
receiving a second message, wherein the second message comprises information of at least one secondary networks allowed for the secondary registration;
selecting, by the wireless device, a target network of the at least one secondary networks; and
sending a third message to a second mobility management node of the target network, wherein the third message requests the secondary registration.

43. An apparatus comprising
a transmitter circuit,
a receiver circuit; and
a controller circuit, wherein the controller circuit is coupled to the transmitter circuit and to the receiver circuit,
wherein the controller circuit is arranged to cause the transmitter circuit to send a first message to a first mobility management node of a network,
wherein the first message indicates support for a secondary registration to a secondary network associated with the network,
wherein the controller circuit is arranged to decode a second message received from the first mobility management node,
wherein the second message comprises information of an allowed network for the secondary registration,
wherein the controller circuit is arranged to cause the transmitter circuit to send a third message to a second mobility management node of the allowed network,
wherein the message requests, the secondary registration.

44. An apparatus comprising:
a transmitter circuit,
a receiver circuit;
a controller circuit, wherein the controller circuit is coupled to the transmitter circuit and to the receiver circuit,
wherein the controller circuit is arranged to decode a first message,
wherein the first message comprises information of at least one secondary networks allowed for secondary registration with the network,
wherein the controller circuit is arranged to cause the transmitter circuit to send a second message to a second mobility management node of an allowed network of the at least one secondary networks, wherein the second message requests secondary registration.
